(19) United States
(12) Patent Application Publication
(10) Pub. No.: US 2023/0116628 A1
(43) Pub. Date: Apr. 13, 2023

(54) PRESSURE-SENSITIVE ADHESIVE SHEET

(71) Applicant: NITTO DENKO CORPORATION, lbaraki-shi, Osaka (JP)

(72) Inventors: Kazuki MINOURA, Ibaraki-shi, Osaka (JP); Masataka NISHIWAKI, Ibaraki-shi, Osaka (JP); Yasushi BUZOUIMA, lbaraki-shi, Osaka (JP)

(73) Assignee: NITTO DENKO CORPORATION, Ibaraki-shi, Osaka (JP)

(21) Appl. No.: 17/913,876

(22) PCT Filed: Mar. 15, 2021
(86) PCT No.: PCT/JP2021/010456

§ 371 Date: Sep. 23, 2022

(30) Foreign Application Priority Data
Mar. 24, 2020 (JP) 2020-051970

(51) Int. Cl. G02F 1/1333; C09J 7/38; C09J 11/04; C08K 3/04; C08F 220/06; C08F 220/18; C08J 5/18

(52) U.S. Cl. CPC G02F 1/133308; C09J 7/385; C09J 11/04; C08K 3/04; C08F 220/06; C08F 220/1804; C08J 5/18; C08K 2201/003; C08K 2201/011; C09J 2203/318; C09J 2301/302; C09J 2301/408; C08J 2333/08; C09J 2301/124; G02F 2202/28

(57) ABSTRACT

To provide a PSA sheet having excellent IR-blocking properties. Provided is a PSA sheet having a PSA layer. The PSA sheet has 5% or lower light transmittance in the thickness direction in a wavelength region of 780 nm to 2500 nm. The PSA sheet has 0.01% or lower light transmittance in an in-plane direction in a wavelength region of 380 nm to 2500 nm.

### TECHNICAL FIELD

The present invention relates to a pressure-sensitive adhesive sheet. The present application claims priority to Japanese Patent Application No. 2020-051970 filed Mar. 24, 2020; the entire content of which is incorporated herein by reference.

### BACKGROUND ART

In general, pressure-sensitive adhesive (PSA) exists as a soft solid (a viscoelastic material) in a room temperature range and has a property to adhere easily to an adherend with some pressure applied. With such properties, PSA is widely used for purposes such as bonding, fixing and protecting components inside portable electronic devices such as cell phones. For instance, in portable electronic devices, light-blocking PSA sheets are used for purposes such as preventing reflection and preventing light leakage from self-luminous elements such as light sources and organic EL (electroluminescence) of backlight modules and the like of liquid crystal displays. Literatures teaching this type of art include Patent Documents 1 and 2.

### CITATION LIST

### Patent Literature

[Patent Document 1] Japanese Patent No. 6574640

[Patent Document 2] Japanese Patent Application Publication No. 2018-28051

### SUMMARY OF INVENTION

### Technical Problem

Thickness reduction and weight reduction have been heretofore demanded of portable electronics. In portable electronics, display enlargement (viewing area enlargement) and designability tend to be of importance, leading to desire for narrower PSA sheets to minimize the compromise of portability associated with display enlargement as well as to enhance the design freedom, etc. As for light-blocking PSA sheet used in these applications, there have also been trends towards thickness reduction and width reduction. However, reduction of the light-blocking PSA sheet thickness and width accompany degradation of light-blocking properties. In such applications, it is desirable to use a PSA sheet having superior light-blocking properties.

Various devices such as the aforementioned sort of portable electronic devices use optical sensors using light such as infrared (IR) light, visible light and ultraviolet (UV) light for purposes including personal identification, device operation, nearby object detection, detection of the surrounding brightness (ambient light) and data communication. For instance, infrared light (IR) sensors can be used in biometric authentication technology for authenticating individuals based on biological information such as fingerprints and veins. In such a device, IR rays from the outside are noise and may reduce the accuracy of the sensor. In a device such as a remote controller (remote control device) whose main body operates with an IR sensor, it is not desirable to have IR leakage elsewhere besides fin the light-emitting part pointed at the target. Therefore, in a light-blocking PSA sheet used for these applications, in addition to preventing light leakage and reflection of the light source in the device, it is also important to block visible light (VIS) and IR in view of preventing malfunction and accuracy degradation of the optical sensor.

However, as a result of the studies by the present inventors, it has been found that even if a conventional light-blocking PSA sheet has excellent VIS-blocking properties, it is insufficient in blocking relatively long-wavelength R. In particular, while the conventional light-blocking PSA sheet has a low light transmittance in the VIS region (380 run to 780 nm), with increasing wavelength, the transmittance tends to increase, having a relatively high transmittance in the IR region (780 nm to 2500 nm). Based on this finding, improvement of IR blocking has been further studied; and as a result, the present invention has been completed. In other words, an objective of this invention is to provide a PSA sheet having excellent IR-blocking properties.

### Solution to Problem

This Description provides a PSA sheet having a PSA layer. The PSA sheet has a thickness-direction light transmittance in 780-2500 nm wavelength region of 5% or lower. The PSA sheet also has an in-plane-direction light transmittance in 380-2500 nm wavelength region of 0.01% or lower. The PSA sheet having such a constitution can exhibit excellent blocking properties against infrared light (IR-blocking properties). The PSA sheet having such a constitution is limited in in-plane-direction light transmittance; and therefore, even when used in narrow width bonding, it can bring about excellent light-blocking properties including the IR region. It is noted that the in-plane direction is a direction along with the plane of the PSA sheet (a direction included in the plane) and can also be called a direction perpendicular to the thickness direction.

The PSA sheet according to some preferable embodiments has a substrate layer supporting the PSA layer. The substrate layer is preferably formed of a resin film comprising a black colorant. Such a constitution preferably brings about the effect of the art disclosed herein. Having the resin film substrate, the PSA sheet may also show excellent precision of machining such as width narrowing. In some embodiments, the substrate layer has a thickness of 10 μm or greater and 50 μm or less.

In some preferable embodiments, the ratio of substrate layer thickness in the total PSA sheet thickness is 40% or higher. When the ratio of substrate layer thickness in the total PSA sheet thickness is the prescribed value or higher, excellent IR-blocking properties are likely to be obtained. For instance, such a constitution can be an especially advantageous feature in a thin PSA sheet having a limited thickness. For instance, the PSA sheet in which the ratio of substrate layer thickness in the total PSA sheet thickness is 40% or higher and 80% or lower may better combine IR-blocking properties with adhesive properties such as adhesive strength.

In some preferable embodiments, the PSA layer comprises a black colorant having a mean particle diameter of 10 nm or greater and less than 1000 nm. The use of a black colorant in the particle diameter range can bring about high levels of light-blocking properties in both thickness and in-plane directions, and excellent IR-blocking properties are likely to be obtained.

The PSA sheet according to some embodiments is a substrate-free double-faced PSA sheet consisting of the PSA layer. The art disclosed herein can bring about excellent IR-blocking properties even in a substrate-free constitution. For instance, the substrate-free PSA sheet is advantageous in terms of impact resistance, etc.

In some embodiments, the PSA sheet has a total thickness of 10 m or greater and less than 75 μm. In other embodiments, the PSA sheet has a total thickness of greater than 50 μm and 300 μm or less. With increasing PSA sheet thickness, IR-blocking properties can be preferably obtained with desirable adhesive properties. From such a standpoint, the total thickness of the PSA sheet can be 75 μm or greater and 300 μm or less. With the PSA sheet having up to a certain thickness, it may well accommodate needs for thinning (thickness reduction) and weight saving. The art disclosed herein can be implemented either as a thin PSA sheet structure or as a relatively thick structure. For instance, the effect of the art disclosed herein can be preferably obtained in a thin PSA sheet having a total thickness of less than 75 μm (e.g., 50 μm or less).

In some preferable embodiments, the PSA sheet has a 180° peel strength to stainless steel plate of 2 N/25 mm or greater. The PSA sheet having such a peel strength can have excellent IR-blocking properties while exhibiting good adhesive properties.

The PSA sheet disclosed herein can be preferably used, for instance, in order to bond members of portable electronic devices such as portable electronics. The electronic devices such as portable electronics and biometric authentication devices may include optical sensors such as IR sensors. Thus, it is particularly significant to block IR with the use of the PSA sheet disclosed herein and ensure accuracy of optical sensors. Such electronic devices may have biometric authentication systems. For instance, among portable electronic devices, those having light sources (luminous components) need to be prevented from light leakage. In addition, for those having display screens, the sort of screen visibility needs to be ensured by preventing internal light reflection as well as reflection of external incident light such as sunlight, etc. Accordingly, it is significant to apply the art disclosed herein to reduce light reflection while preventing light leakage and ensuring screen visibility.

### BRIEF DESCRIPTION OF DRAWINGS

FIG. 1 shows a cross-sectional diagram schematically illustrating a structural example of the PSA sheet.

FIG. 2 shows a cross-sectional diagram schematically illustrating another structural example of the PSA sheet.

FIG. 3 shows a cross-sectional diagram schematically illustrating another structural example of the PSA sheet.

FIG. 4 shows an exploded perspective view schematically illustrating a constitutional example of a liquid crystal display.

FIG. 5 shows a chart showing the thickness-direction 380-2500 nm wavelength light transmittances (%) of the PSA sheets according to Examples 3, 5, 7 and 23.

### DESCRIPTION OF EMBODIMENTS

Preferable embodiments of the present invention are described below. Matters necessary to practice this invention other than those specifically referred to in this description may be comprehended by a person of ordinary skill in the art based on the instruction regarding implementations of the invention according to this description and the common technical knowledge in the pertinent field. The present invention can be practiced based on the contents disclosed in this description and common technical knowledge in the subject field. In the drawings referenced below, a common reference numeral may be assigned to members or sites producing the same effects, and duplicated descriptions are sometimes omitted or simplified. The embodiments described in the drawings are schematized for clear illustration of the present invention, and do not necessarily represent the accurate sizes or reduction scales of the PSA sheet to be provided as an actual product by the present invention.

As used herein, the term “PSA” refers to, as described earlier, a material that exists as a soft solid (a viscoelastic material) in a room temperature range and has a property to adhere easily to an adherend with some pressure applied. As defined in “Adhesion: Fundamental and Practice” by C. A. Dahlquist (McLaren & Sons (1966), P. 143), PSA referred to herein may generally be a material that has a property satisfying complex tensile modulus E* (1 Hz)<10⁷ dyne/cm² (typically, a material that exhibits the described characteristics at 25° C.).

### <Constitutional Examples of PSA Sheet

The PSA sheet disclosed herein can be a substrate-supported PSA sheet having a PSA layer on one or each face of a non-releasable substrate, or a substrate-free PSA sheet (i.e., a PSA sheet free of a non-releasable substrate) in the form of a PSA layer held on a release liner. The concept of PSA sheet herein may encompass so-called PSA tape, PSA labels, PSA film, etc. The PSA sheet disclosed herein can be in a roll or in a flat sheet. Alternatively, the PSA sheet may be processed into various shapes.

For instance, the PSA sheet disclosed herein may have a cross-sectional structure as schematically illustrated in FIG. 1. PSA sheet 1 shown in FIG. 1 has a substrate layer 10 as well as first and second PSA layers 21 and 22 supported on first and second faces 10A and 10B of substrate layer 10, respectively. Both first and second faces 10A and 10B have non-releasable surfaces (non-release faces). For use of PSA sheet 1, the surfaces (first and second adhesive faces) 21A and 22A of first and second PSA layers 21 and 22 are applied to adherends, respectively. In other words, PSA sheet 1 is formed as a double-faced PSA sheet (an adhesively double-faced PSA sheet). This constitutional example uses a resin film comprising a black colorant as substrate layer 10. PSA sheet 1 prior to use is in an embodiment where first and second adhesive faces 21A and 22A are protected with release liners 31 and 32 having releasable surfaces (release faces) at least on their PSA-facing sides. In an alternative embodiment, release liner 32 is omitted; and using a release liner 31 having a release face on each side, PSA sheet 1 can be wound to protect the second adhesive face 22A with the backside of release liner 31 brought in contact therewith. The art disclosed herein is preferably implemented as such a substrate-supported double-faced PSA sheet.

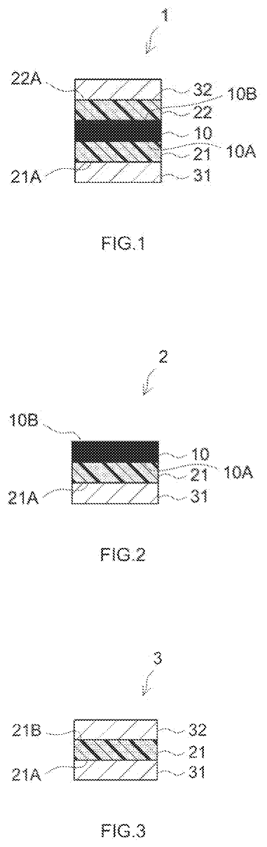

Alternatively, the PSA sheet disclosed herein can be, for instance, an adhesively single-faced PSA sheet having a cross-sectional structure schematically illustrated in FIG. 2. PSA sheet 2 shown in FIG. 2 has a substrate layer 10 and a PSA layer 21 formed on one face (non-releasable) 10A of substrate layer 10. The surface (adhesive face) 21A of PSA layer 21 is the bonding face of PSA sheet 2. The other face 10B of substrate layer 10 constitutes the backside of PSA sheet 2. This PSA sheet 2 has a constitution in which PSA layer 21 is protected with a release liner 31 whose PSA layer 21 side is a release face. Such single-faced PSA sheets are favorable as covering and sealing materials.

PSA sheet 3 shown in FIG. 3 has a constitution in which both faces 21A and 21B of a substrate-free PSA layer 21 are protected with release liners 31 and 32, respectively, each liner having a release face on the PSA layer side. In a possible alternative constitution, release liner 32 is omitted and a release liner 31 whose both faces are release faces is used; and PSA sheet 3 can be wound so that the second adhesive face 21B is brought into contact with the backside of release liner 31, with the second adhesive face 21B also protected with release liner 31. Such substrate-free PSA sheets are readily made thinner and have the advantage of allowing for maximization of PSA properties such as adhesive strength and impact resistance.

### <Poperties of PSA Sheet>

### (IR Transmittance in Thickness Direction)

The PSA sheet disclosed herein is characterized by having a thickness-direction light transmittance in 780-2500 nm wavelength region of 5% or lower. In other words, the PSA sheet has 5% or lower IR transmittance (light transmittance in the wavelength range of 780 nm to 2500 nm). The IR transmittance is the transmittance in the thickness direction of the PSA sheet. The PSA sheet satisfying this property has excellent IR-blocking properties. The PSA sheet has a thickness-direction IR transmittance of, for instance, 3% or lower, or suitably 1% or lower. From the standpoint of the IR-blocking properties, the thickness-direction IR transmittance of the PSA sheet is preferably 0.50% or lower, more preferably 0.30% or lower, yet more preferably 0.10% or lower, particularly preferably 0.03% or lower, or most preferably 0.01% or lower (e.g., below 0.01%). The minimum IR transmittance can be essentially 0% (i.e., at or below detection limit) or 0.01% (e.g., 0.001%).

### (VIS Transmittance in Thickness Direction)

The PSA sheet disclosed herein may also have a limited 380-780 nm wavelength light transmittance in the thickness direction. In other words, the PSA sheet may have a certain percent or lower VIS transmittance (light transmittance in the wavelength region of 380 nm to 780 nm). The VIS transmittance is the transmittance in the thickness direction of the PSA sheet. In addition to the IR transmittance, the PSA sheet having a low VIS transmittance is suited for light-blocking applications because it has excellent VIS/IR-blocking properties in the thickness direction. The thickness-direction VIS transmittance of the PSA sheet is not limited to a specific range as long as the IR transmittance is satisfied. It can be, for instance, 1% or lower, suitably 0.3% or lower, possibly 0.1% or lower, or even 0.03% or lower. From the standpoint of the light-blocking properties, the PSA sheet according to some embodiments has a thickness-direction VIS transmittance of 0.01% or lower (e.g., below 0.01%). The minimum VIS transmittance can be essentially 0% (i.e., at or below detection limit), for instance, 0.01%.

### (Light Transmittance in In-Plane Direction)

The PSA sheet disclosed herein may have a limited 380-2500 nm wavelength light transmittance in an in-plane direction. In other words, the PSA sheet may have a certain percent or lower in-plane-direction light transmittance in the wavelength region of 380 nm to 2500 nm. The light transmittance is the light transmittance in the wavelength region (380-2500 nm) in an in-plane direction of the PSA sheet and the transmission distance in the in-plane direction is 0.2 mm. Accordingly, the in-plane-direction light transmittance can be referred to as the in-plane-direction 0.2 mm-distance light transmittance in 380-2500 nm wavelength region, or as the in-plane-direction light transmittance through 0.2 mm distance (possibly 0.2 mm width)(380-2500 nm wavelength). The PSA sheet with the limited light transmittance is suited for light-blocking applications as it has high in-plane-direction VIS/IR-blocking properties. The maximum in-plane-direction light transmittance in 380-2500 nm wavelength region is not particularly limited. In some embodiments, it is, for instance, 1% or lower, suitably 0.3% or lower, possibly 0.1% or lower, or even 0.03% or lower. In some preferable embodiments, the in-plane-direction light transmittance in 380-2500 nm wavelength region is 0.01% or lower (e.g., below 0.01%). The PSA sheet satisfying this property blocks VIS and IR well in in-plane directions, having excellent light-blocking properties including the IR region. The minimum light transmittance can be essentially 0% (i.e., at or below detection limit) or 0.01% (e.g., 0.001%).

The thickness-direction IR transmittance, VIS transmittance and in-plane-direction light transmittance can be adjusted by suitably selecting components (typically, a species of black colorant and its amount) included in the PSA and substrate based on the content of this Description. The thickness-direction IR transmittance, VIS transmittance and in-plane-direction light transmittance are determined by the methods described later in Examples.

### (Adhesive Strength)

The 180° peel strength (adhesive strength) of the PSA sheet disclosed herein may vary depending on the purpose and application area and thus is not limited to a specific range. The PSA sheet may have an adhesive strength of, for instance, 0.3 N/25 mm or greater. From the standpoint of obtaining good adhesion to adherends, the 180° peel strength is suitably about 1.0 N/25 mm or greater, preferably about 2.0 N/25 mm or greater, more preferably about 3.0 N/25 mm or greater, or yet more preferably about 4.0 N/25 mm or greater (e.g., about 5.0 N/25 mm or greater). The PSA sheet having such an adhesive strength can exhibit good bonding properties while having excellent IR-blocking properties. For instance, it is suited for bonding members. In some embodiments, from the standpoint of the stability of bonding to adherends, the adhesive strength can be about 8 N/25 mm or greater, or even about 12N/25 mm or greater (e.g., about 15 N/25 mm or greater). The maximum adhesive strength is not particularly limited and is, for instance, 30 N/25 mm or less, or possibly 24 N/25 mm or less (e.g., 20 N/25 mm or less). In some embodiments, from the standpoint of the IR-blocking properties, thickness reduction and so on, the PSA sheet can have an adhesive strength of about 18 N/25 mm or less, about 15 N/25 mm or less, or even about 8 N/25 mm or less (e.g., about 6 N/25 mm or less). The 180° peel strength can be determined by the method described later in Examples.

### <PSA Layer>

### (Base Polymer)

In the art disclosed herein, the type of the PSA constituting the PSA layer is not particularly limited. The PSA layer may comprise, as its base polymer, one, two or more species among various rubber-like polymers such as acrylic polymer, rubber-based polymer, polyester-based polymer, urethane-based polymer, polyether-based polymer, silicone-based polymer, polyamide-based polymer, and fluoropolymer. From the standpoint of the adhesive properties, cost, etc., a preferable PSA comprises an acrylic polymer or a rubber-based polymer as the base polymer. In particular, an acrylic PSA (a PSA whose base polymer is an acrylic polymer) is preferable. In the following, a PSA sheet having an acrylic PSA layer (i.e., a PSA layer formed of an acrylic PSA) is mainly described; however, the PSA layer in the PSA sheet disclosed herein is not to be limited to those formed of acrylic PSA.

The “base polymer” of a PSA refers to a rubber-like polymer in the PSA; besides this, it is not limited to any specific interpretation. The rubber-like polymer refers to a polymer that shows rubber elasticity around room temperature. As used herein, the “main component” (primary component) refers to a component accounting for more than 50% by weight.

The “acrylic polymer” refers to a polymer that includes a monomeric unit derived from a monomer having at least one (meth)acryloyl group per molecule. Hereinafter, a monomer having at least one (meth)acryloyl group per molecule is referred to as an “acrylic monomer.” Thus, as used herein, the acrylic polymer is defined to be a polymer that includes a monomeric unit derived from an acrylic monomer. Typical examples of the acrylic polymer include an acrylic polymer in which the acrylic monomer accounts for more than 50% by weight of all monomers used in synthesizing the acrylic polymer.

As used herein, the term “(meth)acryloyl” is meant to be inclusive of acryloyl and methacryloyl. Likewise, “(meth)acrylate” means acrylate and methacrylate, and “(meth)acryl” is meant to be inclusive of acryl and methacryl respectively.

### (Acrylic Polymer)

A preferable example of the acrylic polymer used in the art disclosed herein is a polymer formed from a starting monomer mixture that comprises an alkyl (meth)acrylate as the primary monomer. Here, the primary monomer refers to a component that accounts for more than 50% by weight of the monomer composition of the starting monomer mixture.

For example, a compound represented by the following formula (1) can be advantageously used as the alkyl(meth)acrylate.

CH₂═C(R¹)COOR² (1)

Here, R¹ in the formula (l) is a hydrogen atom or a methyl group. R² is an acyclic alkyl group having 1 to 20 carbon atoms (hereinafter such a range of the number of carbon atoms may be expressed as “C₁₋₂₀”). From the standpoint of the storage elastic modulus of the PSA and the like, the primary monomer is suitably an alkyl (meth)acrylate in which R² is a acyclic C₁₋₄ (e.g., C₂₋₁₀, typically C₄₋₈)alkyl group. From the standpoint of the adhesive properties, the primary monomer is preferably an alkyl acrylate in which R¹ is a hydrogen atom and R² is an acyclic C₄₋₈ alkyl group (which may also be simply referred to as a C₄₋₈ alkyl acrylate).

Examples of the alkyl(meth)acrylate having a C₁₋₂₀ acyclic alkyl group for R² include methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, pentyl (meth)acrylate, isopentyl (meth)acrylate, hexyl (meth)acrylate, heptyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, lauryl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, and eicosyl (meth)acrylate. These alkyl (meth)acrylates can be used singly as one species or in a combination of two or more species. Preferable alkyl (meth)acrylates include n-butyl acrylate (BA) and 2-ethylhexyl acrylate (2EHA).

Typically, the amount of the alkyl (meth)acrylate among the monomeric components constituting the acrylic polymer is more than 50% by weight, for example 70% by weight or more, may be 85% by weight or more, or may be even 90% by weight or more. The maximum percent of the alkyl (meth)acrylate is not particularly limited. It is preferably 99.5% by weight or less (e.g., 99% by weight or less); or from the standpoint of preferably obtaining properties (e.g., cohesive strength) based on a secondary monomer such as a carboxy group-containing monomer, it may be 98% by weight or less (e.g., less than 97% by weight). Alternatively, the acrylic polymer may be a polymer essentially formed of an alkyl(meth)acrylate.

When using a C₄₋₈ alkyl acrylate as a monomer, of the alkyl (meth)acrylate content of the monomers the C₄₋₈ alkyl acrylate accounts for preferably 70% by weight or more, or more preferably 90% by weight or more. For instance, the monomers may comprise 2EHA in a lower proportion than BA.

The art disclosed herein can be preferably implemented in an embodiment in which the starting monomer mixture includes at least 50% by weight of C₁₋₄ alkyl (meth)acrylate. The ratio of C₁₋₄ alkyl (meth)acrylate in the monomers may be 70% by weight or higher, or may be 85% by weight or higher (e.g., 90% by weight or higher). According to an acrylic polymer having a monomer composition comprising at least a prescribed amount of C₁₋₄ alkyl (meth)acrylate, in an embodiment comprising an undermentioned black colorant (typically carbon black particles), the black colorant tends to disperse well in the PSA, enhancing the IR-blocking properties. On the other hand, from the standpoint of the cohesive strength, etc., the ratio of C₁₋₄ alkyl (meth)acrylate in the starting monomers is usually suitably 99.5% by weight or lower, and this amount may be 98% by weight or lower (for example, 97% by weight or lower).

The art disclosed herein can be preferably implemented in an embodiment in which the C₂₋₄ alkyl acrylate accounts for 50% by weight or more (e.g., 70% by weight or more, 85% by weight or more, or 90% by weight or more) of the monomers. The Cu alkyl acrylates can be used singly as one species or in a combination of two or more species. According to such an embodiment, the resulting PSA sheet is likely to show tight adhesion to an adherend. In a preferable embodiment, BA accounts for more than 50% by weight (e.g., 70% by weight or more, or 85% by weight or more, or 90% by weight or more) of the monomers. When the C₂₋₄ alkyl acrylate (e.g., BA) is used at least in a prescribed amount, even if a black colorant (e.g., carbon black) is added to the PSA, the colorant can be well dispersed in the layer while maintaining good levels of adhesive properties such as adhesive strength. An acrylic polymer having such a monomer composition is likely to bring about improved IR-blocking properties and further achieve IR-blocking properties combined with adhesive properties. On the other hand, from the standpoint of obtaining satisfactory cohesive strength, etc., the ratio of C₂₋₄ alkyl (meth)acrylate in the monomers is usually suitably 99.5% by weight or lower, or possibly 98% by weight or lower (e.g., below 97% by weight).

In other embodiments, the starting monomer mixture may include at least 50% by weight (e.g., at least 70% by weight, at least 85% by weight or at least 90% by weight) of C₅₋₂₀ alkyl (meth)acrylate. A preferable C₅₋₂₀ alkyl (meth)acrylate is a C₆₋₁₄ alkyl (meth)acrylate. In some embodiments, a C₆₋₁₀ alkyl acrylate (e.g., a C₈₋₁₀ alkyl acrylate) can be preferably used.

A secondary monomer may be copolymerized in the acrylic polymer in the art disclosed herein. Secondary monomers can introduce functional groups capable of constituting cross-linking points in the acrylic polymer or can contribute to increasing adhesive strength. Examples of such secondary monomer include carboxy group-containing monomers, hydroxyl group (OH group)-containing monomers, acid anhydride group-containing monomers, amide group-containing monomers, amino group-containing monomers, epoxy group-containing monomers, cyano group-containing monomers, keto group-containing monomers, monomer having a nitrogen atom-containing ring, alkoxysilyl group-containing monomers and imide group-containing monomers. For the secondary monomer, solely one species or a combination of two or more species can be used.

A preferable example of the acrylic polymer in the art disclosed herein is an acrylic polymer in which a carboxy group-containing monomer is copolymerized as the secondary monomer. Examples of the carboxy group-containing monomer include ethylenically-unsaturated monocarboxylic acids such as acrylic acid (AA), methacrylic acid (MAA), carboxyethyl (meth)acrylate, carboxypentyl (meth)acrylate, crotonic acid, and isocrotonic acid, and ethylenically-unsaturated dicarboxylic acids such as maleic acid, itaconic acid and citraconic acid as well as their anhydrides (maleic acid anhydride, itaconic acid anhydride, etc.). In particular, AA and MAA are preferable.

Other favorable examples include an acrylic polymer in which a hydroxy group-containing monomer is copolymerized as the secondary monomer. Examples of hydroxy group-containing monomers include hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, and 4-hydroxybutyl (meth)acrylate; polypropylene glycol mono (meth)acrylate; and N-hydroxyethyl (meth)acrylamide. A particularly preferable hydroxy group-containing monomer is a hydroxyalkyl (meth)acrylate having a linear alkyl group with 2 to 4 carbon atoms.

Examples of amide group-containing monomers include (meth)acrylamide, N,N-dimethyl (meth)acrylamide, N-butyl (meth)acrylamide, N-methylol (meth)acrylamide, N-methylolpropane (meth)acrylamide, N-methoxymethyl (meth)acrylamide, and N-butoxymethyl (meth)acrylamide.

Examples of amino group-containing monomers include aminoethyl (meth)acrylate, N,N-dimethylaminoethyl (meth)acrylate, and t-butylaminoethyl (meth)acrylate.

Examples of epoxy group-containing monomers include glycidyl (meth)acrylate, methylglycidyl (meth)acrylate, and allyl glycidyl ether.

Examples of cyano group-containing monomers include acrylonitrile and methacrylonitrile.

Examples of keto group-containing monomers include diacetone (meth)acrylamide, diacetone (meth)acrylate, vinyl methyl ketone, vinyl ethyl ketone, allyl acetoacetate, and vinyl acetoacetate.

Examples of monomers having a nitrogen atom-containing ring include N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-vinylmorpholine, N-vinylcaprolactam, and N-(meth)acryloylmorpholine.

Examples of alkoxysilyl group-containing monomers include 3-(meth)acryloxypropyltrimethoxysilane, 3-(meth)acryloxypropyltriethoxysilane, 3-(meth)acryloxypropylmethyldimethoxysilane, and 3-(meth)acryloxypropylmethyldimethoxysilane.

When the monomers forming the acrylic polymer include an aforementioned functional group-containing monomer, the amount of the functional group-containing monomer among the monomeric components is not particularly limited. From the standpoint of suitably exhibiting the effect of using the functional group-containing monomer, the amount of the functional group-containing monomer among the monomeric components can be, for example, 0.1% by weight or more, a suitable amount is 0.5% by weight or more, and this amount may be 1% by weight or more. From the standpoint of facilitating the balance of adhesive performance in relation to the primary monomer, a suitable amount of the functional group-containing monomer among the monomeric components is 40% by weight or less, and this amount is preferably 20% by weight or less, or may be 10% by weight or less (e.g., 5% by weight or less).

In the acrylic polymer according to some preferable embodiments, the monomers forming the acrylic polymer may include a carboxy group-containing monomer. The monomers including the carboxy group-containing monomer are likely to result in a PSA sheet showing good adhesive properties (cohesive strength, etc.). This can be advantageous in improving the tightness of adhesion between the PSA layer and the adherend. Furthermore, for instance, when a black colorant such as carbon black is added to the PSA, copolymerization of a carboxy group-containing monomer in a suitable amount facilitates dispersion of the colorant in the layer and the adhesive properties can be preferably retained. An acrylic polymer having such a monomer composition is likely to bring about improved IR-blocking properties and further achieve IR-blocking properties combined with adhesive properties. For the carboxy group-containing monomer, solely one species or a combination of two or more species can be used.

In an embodiment in which a carboxy group-containing monomer is copolymerized in the acrylic polymer, the amount of carboxy group-containing monomer in the monomers forming the acrylic polymer is not particularly limited and it can be, for example, 0.2% by weight or more (typically 0.5% by weight or more) of the monomers. It is suitably 1% by weight or more or can be 2% by weight or more, or even 3% by weight or more. With more than 3% carboxy group-containing monomer by weight, a greater effect (e.g., IR-blocking property enhancement) can be obtained. In some preferable embodiments, the amount of carboxy group-containing monomer in the monomers can be 3.2% by weight or more, 3.5% by weight or more, 4% by weight or more, or even 4.5% by weight or more. The maximum amount of carboxy group-containing monomer is not particularly limited. For instance, it can be 15% by weight or less, 12% by weight or less, or even 10% by weight or less. With the copolymerization ratio of carboxy group-containing monomer limited up to a certain amount, for instance, even when the PSA includes a black colorant such as carbon black particles, the colorant can be well dispersed in the layer while maintaining good levels of adhesive properties such as adhesive strength. The art disclosed herein can be preferably implemented in an embodiment in which the carboxy group-containing monomer content is 7% by weight or less (typically less than 7% by weight. e.g., 6.8% by weight or less, or 6.0% by weight or less).

The art disclosed herein can be preferably implemented in an embodiment where the monomers are essentially free of a functional group-containing monomer besides a carboxy group-containing monomer (or a non-carboxy functional group-containing monomer)(e.g., an embodiment where the monomers essentially consist of an alkyl (meth)acrylate and a carboxy group-containing monomer). Here, that the monomers are essentially free of a non-carboxy functional group-containing monomer refers to at least absence of deliberate use of non-carboxy functional group-containing monomer, possibly allowing non-deliberate inclusion of non-carboxy functional group-containing monomer, for instance, up to about 0.05% by weight (typically up to 0.01% by weight). An acrylic polymer having such a monomer composition may allow, for instance, easy dispersion of a black colorant such as carbon black.

The monomers forming the acrylic polymer may include other comonomer besides the secondary monomer for the purpose of improving the cohesiveness or the like. Examples of the other comonomer include vinyl ester monomers such as vinyl acetate, vinyl propionate, and vinyl laurate; aromatic vinyl compounds such as styrene, substituted styrene (α-methylstyrene and the like), and vinyl toluene; cycloalkyl (meth)acrylates such as cyclohexyl (meth)acrylate, cyclopentyl (meth)acrylate, and isobornyl (meth)acrylate; aromatic ring-containing (meth)acrylates such as aryl (meth)acrylates (e.g., phenyl (meth)acrylate), aryloxyalkyl (meth)acrylates (e.g., phenoxyethyl (meth)acrylate), and arylalkyl (meth)acrylates (e.g., benzyl (meth)acrylate); olefinic monomers such as ethylene, propylene, isoprene, butadiene, and isobutylene; chlorine-containing monomers such as vinyl chloride and vinylidene chloride; isocyanate group-containing monomers such as 2-(meth)acryloyloxyethyl isocyanate; alkoxy group-containing monomers such as methoxyethyl (meth)acrylate and ethoxyethyl (meth)acrylate; vinyl ether monomers such as methyl vinyl ether and ethyl vinyl ether; and polyfunctional monomers having two or more (e.g., three or more) polymerizable functional groups (e.g., (meth)acryloyl groups) in a molecule, such as 1,6-hexanediol di(meth)acrylate and trimethylolpropane tri(meth)acrylate. These other comonomers can be used singly as one species or in a combination of two or more species.

The amount of such other comonomer is not particularly limited and may be suitably selected according to the purpose and application. From the standpoint of suitably obtaining the effect of the use thereof, a suitable amount is 0.05% by weight or more, and this amount may be 0.5% by weight or more. From the standpoint of facilitating the balance of the PSA performance, a suitable amount of the other copolymerizable component among the monomeric components is 20% by weight or less, and this amount may be 10% by weight or less (e.g., 5% by weight or less). The art disclosed herein also can be preferably implemented in an embodiment in which the monomeric components include substantially no other copolymerizable components. Here, the expression that the monomeric components include substantially no other copolymerizable monomers means that no other copolymerizable monomers is used at least intentionally. For example, it may allow non-deliberate inclusion of other monomers up to about 0.01% by weight. An acrylic polymer having such a monomer composition may allow, for instance, easy dispersion of a black colorant such as carbon black.

The copolymer composition of the acrylic polymer can be suitably designed so that the polymer has a glass transition temperature (Tg) of about −15° C. or below (e.g., about −70° C. or above and −15° C. or below). Here, the acrylic polymer's Tg refers to the Tg value determined by the Fox equation based on the composition of the monomers used in the synthesis of the polymer. As shown below, the Fox equation is a relational expression of the Tg of a copolymer and the glass transition temperatures Tgi of the homopolymers obtained by homopolymerization of the monomers constituting the copolymer.

1/Tg=Σ(Wi/Tgi)

In the Fox equation above, Tg represents the glass transition temperature (unit: K) of the copolymer, Wi the weight fraction (copolymerization ratio by weight) of a monomer i in the copolymer, and Tgi the glass transition temperature (unit: K) of the homopolymer of the monomer i.

As for the glass transition temperatures of homopolymers used in Tg determination, values disclosed in publicly known resources are used. For instance, with respect to the monomers listed below, as the glass transition temperatures of their corresponding homopolymers, the following values are used.

| | | |
|---|---|---|
| 2-ethylhexyl acrylate | −70° | C. |
| isononyl acrylate | −60° | C. |
| n-butyl acrylate | −55° | C. |
| ethyl acrylate | −22° | C. |
| methyl acrylate | 8° | C. |
| methyl methacrylate | 105° | C. |
| 2-hydroxyethyl acrylate | −15° | C. |
| 4-hydroxybutyl acrylate | −40° | C. |
| vinyl acetate | 32° | C. |
| acrylic acid | 106° | C. |
| methacrylic acid | 228° | C. |

With respect to the Tg values of the homopolymers of other monomers besides those exemplified above, the values given in “Polymer Handbook” (3rd edition, John Wiley & Sons, Inc., Year 1989) are used. When the Polymer Handbook provides two or more values for a certain monomer, the highest value is used. In the case where the values are not described in the Polymer Handbook, those that can be obtained by the measuring method described in Japanese Patent Application Publication No. 2007-51271 is used.

While no particular limitations are imposed, from the standpoint of the impact resistance and tightness of adhesion to an adherend, the Tg of the acrylic polymer is advantageously about −25° C. or lower, preferably about −35° C. or lower, and more preferably about 40° C. or lower, but these values are not particularly limiting. In some embodiments, from the standpoint of cohesiveness, the Tg of the acrylic polymer may be, for example, about −65° C. or higher, about −60° C. or higher, or about −55° C. or higher. The art disclosed herein can be preferably implemented in an embodiment in which the Tg of the acrylic polymer is about −65° C. or higher and about −35° C. or lower (e.g., about −55° C. or higher and about −40° C. or lower). The Tg of the acrylic polymer can be adjusted by suitably changing the monomer composition (that is, the type of monomers used for synthesizing the polymer and the ratio of the amounts used).

The method for obtaining the acrylic polymer is not particularly limited. Various polymerization methods known as synthetic means for acrylic polymers can be suitably employed, with the methods including solution polymerization method, emulsion polymerization, bulk polymerization, suspension polymerization, and photopolymerization. For example, a solution polymerization method can be preferably used. The polymerization temperature in the solution polymerization can be suitably selected according to the types of monomers and solvent to be used, the type of polymerization initiator, and the like. It can be, for example, about 20° C. to 170° C. (typically, about 40° C. to 140° C.).

As for the solvent (polymerization solvent) used in solution polymerization, a suitable species can be selected among heretofore known organic solvents. For instance, one species of solvent or a mixture of two or more species of solvent can be used, selected among aromatic compounds (typically aromatic hydrocarbons) such as toluene; acetic acid esters such as ethyl acetate; aliphatic or alicyclic hydrocarbons such as hexane and cyclohexane; halogenated alkanes such as 1,2-dichloroethane; lower alcohols (e.g., monohydric alcohols with one to four carbon atoms) such as isopropanol; ethers such as tert-butyl methyl ether, and ketones such as methyl ethyl ketone.

The initiator used for polymerization can be suitably selected among heretofore known polymerization initiators according to the type of polymerization method. For example, one or two or more species of azo polymerization initiators such as 2,2′-azobisisobutyronitrile (AIBN) can be preferably used. Other examples of the polymerization initiator include persulfates such as potassium persulfate; peroxide initiators such as benzoyl peroxide and hydrogen peroxide; substituted ethane initiators such as phenyl-substituted ethane; and aromatic carbonyl compounds. Still other examples of the polymerization initiator include redox type initiators based on a combination of a peroxide and a reducing agent. Such polymerization initiators can be used singly as one species or in a combination of two or more species. The polymerization initiator can be used in a typical amount, for example, about 0.005 part to 1 part by weight (typically, about 0.01 part to 1 part by weight) to 100 parts by weight of the monomers.

The solution polymerization yields a polymerization reaction mixture as a solution of acrylic polymer in an organic solvent. The PSA layer in the art disclosed herein may be formed from a PSA composition comprising the polymerization reaction mixture or an acrylic polymer solution obtained by subjecting the reaction mixture to a suitable work-up. For the acrylic polymer solution, the polymerization reaction mixture can be used after adjusted to suitable viscosity and/or concentration as necessary. Alternatively, an acrylic polymer can be synthesized by a polymerization method other than solution polymerization, such as emulsion polymerization, photopolymerization, bulk polymerization, etc., and an acrylic polymer solution prepared by dissolving the acrylic polymer in an organic solvent can be used as well.

The weight average molecular weight (Mw) of the base polymer (preferably acrylic polymer) in the art disclosed herein is not particularly limited, and may be, for example, in the range of about 10×10⁴ to 500×10⁴. From the standpoint of the adhesive properties, the Mw of the base polymer is in the range of about 30×10⁴ to 200×10⁴ (more preferably, about 45×10⁴ to 150×10⁴, typically about 65×10⁴ to 130×10⁴). The use of base polymer with Mw in these ranges is likely to bring about excellent IR-blocking properties in an embodiment comprising a black colorant (typically carbon black particles). Here, Mw refers to a value obtained based on polystyrene standards by gel permeation chromatography (GPC). As the GPC apparatus, for example, model name “HLC-8320 GPC” (column: TSK gel GMH-H (S), available from Tosoh Corporation) can be used.

### (Black Colorant)

In typical, the PSA layer disclosed herein preferably comprises a black colorant. The use of black colorant preferably brings about excellent IR-blocking properties. Specific examples of the black colorant include carbon black, graphite, aniline black, perylene black, titanium black, cyanine black, activated carbon, molybdenum disulfide, chromium complexes, and anthraquinone-based colorants. For the black colorant, solely one species or a suitable combination of two or more species can be used.

In some preferable embodiments, the PSA layer comprises carbon black particles. As the carbon black particles for use, species generally called carbon black (furnace black, channel black, acetylene black, thermal black, lamp black, turpentine soot, etc.) can be used without particular limitations. As the carbon black particles, it is also possible to use surface-modified carbon black particles having a functional group such as carboxy group, amino group, sulfonate group and silicon-containing group (e.g., alkoxysilyl group, alkylsilyl group). Such surface-modified carbon black particles are also called self-dispersible carbon black with which dispersant addition may be unnecessary or the amount added can be reduced. For the carbon black particles, solely one species or a combination of two or more species can be used.

In an embodiment where the PSA layer comprises carbon black particles, the amount of a non-carbon-black black colorant (i.e., a black colorant other than carbon black particles) in the PSA layer is not particularly limited. It is, for instance, possibly below 13% by weight, preferably below 10% by weight, also possibly, for instance, below 5% by weight, or even below 3.0% by weight (e.g., below 2.0% by weight, or even below 1% by weight). The art disclosed hemin can be preferably implemented in an embodiment in which the PSA layer is essentially free of a non-carbon-black black colorant. As used herein, “essentially free of” means absence of deliberate addition unless otherwise noted. For instance, the amount in the PSA layer can be 03% by weight or less (e.g., 0.1% by weight or less, or typically 0.01% by weight or less).

From the standpoint of efficiently obtaining IR-blocking properties with the use of a small amount, in some preferable embodiments, a black colorant (favorably carbon black particles) having a mean particle diameter of about 10 nm or larger (e.g., about 30 nm or larger) can be used. The mean particle diameter can be, for instance, about 50 nm or greater, about 100 nm or greater, or even about 150 nm or greater. A black colorant having such a mean particle diameter tends to show good dispersion stability in the PSA layer and intralayer transfer (e.g., bleeding out) is unlikely to occur. The maximum mean particle diameter of the black colorant is not particularly limited. For instance, it is suitably about 3000 nm or less, or possibly about 1500 nm or less (e.g., 1200 nm or less). From the standpoint of increasing the IR-blocking properties, the black colorant's mean particle diameter can be preferably less than 1000 nm, more preferably less than 500 nm, yet more preferably less than 300 nm, or possibly less than 250 an (e.g., about 220 nm or less). A black colorant having a mean particle diameter in these ranges tends to disperse well in the PSA layer when added in a relatively small amount and bring about excellent IR-blocking properties.

Here, the mean particle diameter of the black colorant (favorably carbon black particles) refers to the median volume diameter, in particular, the particle diameter at the 50th percentile (the 50th-percentile particle diameter, which may be abbreviated as D₅₀ hereinafter) in its size distribution obtained by a particle size meter based on laser scattering/diffraction. As the analyzer, for instance, product name MICROTRAC MT3000II available from MicrotracBEL Corporation or a comparable product can be used.

In the art disclosed herein, the form of addition of the black colorant (favorably carbon black particles) to the PSA composition is not particularly limited. The black colorant can be added to the PSA composition in the form of a dispersion in which the particles are dispersed in a dispersion medium. The dispersion medium forming the dispersion is not particularly limited. Examples include water (ion-exchanged water, reverse osmosis water, distilled water, etc.), various organic solvents (alcohols such as ethanol; ketones such as acetone; ethers such as butyl cellosolve, propylene glycol monomethyl ether acetate; esters such as ethyl acetate; aromatic hydrocarbons such as toluene; mixed solvents of these), and aqueous mixed solvents of water and these organic solvents. The dispersion may also comprise an aforementioned dispersant. By mixing the dispersion with a PSA composition, the PSA composition may also further comprise the dispersant while comprising the black colorant.

The black colorant content (favorably carbon black particles) is not particularly limited. It can be suitably selected in view of the PSA layer thickness, light-blocking properties to be obtained, required adhesive properties etc. The black colorant content of the PSA layer is possibly about 0.1% by weight or higher (e.g., about 0.5% by weight or higher), suitably about 1% by weight or higher, or also possibly about 1.5% by weight or higher. Such a black colorant content is favorable when the PSA layer has a sufficient thickness, or when the substrate layer has at least a certain level of light-blocking properties, etc. In some preferable embodiments, from the standpoint of obtaining sufficient IR-blocking properties, the black colorant content of the PSA layer is about 2% by weight or higher, more preferably about 4% by weight or higher, yet more preferably about 5% by weight or higher (e.g., about 6% by weight or higher), particularly preferably 7% by weight or higher, or possibly even about 8% by weight or higher (e.g., about 10% by weight or higher). The black colorant content is possibly about 50% by weight or lower, suitably about 30% by weight or lower, or possibly even about 20% by weight or lower. From the standpoint of the adhesive properties, etc., the black colorant content is preferably about 10% by weight or lower, more preferably about 7.5% by weight or lower, yet more preferably about 4.5% by weight or lower, or possibly about 2.5% by weight or lower (e.g., about 2.0% by weight or lower). When the adhesive properties such as adhesive strength are of more importance, the black colorant content is preferably in these ranges.

The PSA composition disclosed herein may comprise a component that contributes to enhancing the dispersity of the black colorant (favorably carbon black particles). The dispersity enhancer can be, for instance, a polymer, oligomer, liquid resin or surfactant (anionic, cationic, nonionic or amphoteric surfactant). As the dispersity enhancer, solely one species or a combination of two or more species can be used. The dispersity enhancer is preferably dissolved in the PSA composition. The oligomer can be a low molecular weight polymer formed of monomers including one, two or more species of acrylic monomer as the examples shown earlier (e.g., an acrylic oligomer having a Mw below about 10×10⁴, or preferably below 5×10⁴). The liquid resin can be, for instance, a tackifier resin (typically, a rosin-based, terpene-based, or hydrocarbon-based tackifier resin, or the like, e.g., hydrogenated rosin methyl ester, etc.). Such a dispersity enhancer can inhibit uneven dispersion of the black colorant and further inhibit uneven coloring of the PSA layer. Therefore, a PSA sheet can be formed with a good appearance.

The form of addition of the dispersity enhancer is not particularly limited. It can be included in a solution comprising the black colorant (favorably carbon black particles) prior to addition to the PSA composition; or it can be supplied into the PSA composition before, simultaneously with, or after the addition of the black colorant.

The amount of dispersity enhancer is not particularly limited. From the standpoint of reducing its influence on the adhesive properties (e.g., lowering of the cohesion), relative to the entire PSA layer, it is suitably about 20% by weight or less (preferably about 10% by weight or less, more preferably 7% by weight or less, e.g., about 5% by weight or less). In some embodiments, the amount of dispersity enhancer can be up to about 10-fold (preferably up to about 5-fold, e.g., up to about 3-fold) of the weight of the black colorant (favorably carbon black particles). On the other hand, from the standpoint of favorably obtaining the effect of dispersity enhancer, its amount is suitably about 0.2% by weight or more (typically about 0.5% by weight or more, preferably about 1% by weight or more) of the entire PSA layer. In some embodiments, the amount of dispersity enhancer can be at least about 02-fold (preferably at least about 0.5-fold, e.g., at least 1-fold) of the black colorant's weight.

### (Tackifier Resin)

The PSA layer in the art disclosed herein may include a tackifier resin. This can increase the peel strength of the PSA sheet. As the tackifier resin, one, two or more species can be used, selected among various known tackifier resins such as a phenolic tackifier resin, a terpene tackifier resin, a modified terpene tackifier resin, a rosin tackifier resin, a hydrocarbon tackifier resin, an epoxy tackifier resin, a polyamide tackifier resin, an elastomer tackifier resin, and a ketone tackifier resin.

Examples of the phenolic tackifier resins include terpene phenolic resins, hydrogenated terpene phenolic resins, alkylphenolic resins, and rosin phenolic resins.

The term “terpene phenolic resin” refers to a resin including a terpene residue and a phenol residue, and is inclusive of both a copolymer of a terpene and a phenol compound (terpene-phenol copolymer resin) and a phenol-modified homopolymer or copolymer of a terpene (phenol-modified terpene resin). Preferable examples of terpenes constituting such terpene phenolic resins include monoterpenes such as α-pinene, β-pinene, and limonene (including d-form, l-form and d/l form (dipentene)). The hydrogenated terpene phenolic resin has a structure obtained by hydrogenating such a terpene phenolic resin. Such a resin is sometimes referred to as a hydrogen-added terpene phenolic resin.

The alkylphenolic resin is a resin (oily phenolic resin) obtainable from an alkylphenol and formaldehyde. Examples of alkylphenol resins include novolac type and resole type resins.

A rosin phenolic resin is typically a phenol-modified product of rosins or various rosin derivatives (including rosin esters, unsaturated fatty acid-modified rosins, and unsaturated fatty acid-modified rosin esters) described later. Examples of the rosin phenolic resin include rosin phenolic resins obtained, for example, by a method of adding a phenol to a rosin or the rosin derivative with an acid catalyst and thermally polymerizing.

Examples of terpene-based tackifier resins include polymers of terpenes (typically monoterpenes) such as α-pinene, β-pinene, d-limonene, l-limonene, and dipentene. The polymer may be a homopolymer of one type of terpene or a copolymer of two or more types of terpenes. The homopolymers of one type of terpene can be exemplified by an α-pinene polymer, β-pinene polymer, and a dipentene polymer. The modified terpene resin is exemplified by modifications of the terpene resin. Specific examples include styrene-modified terpene resins and hydrogenated terpene resins.

The term “rosin-based tackifier resin” as used herein is inclusive of both rosins and rosin derivative resins. Examples of rosins include unmodified rosins (raw rosins) such as gum rosin, wood rosin, and tall oil rosin, and modified rosins obtained by modification of the unmodified rosins by hydrogenation, disproportionation, polymerization, and the like (hydrogenated rosins, disproportionated rosins, polymerized rosins, and other chemically modified rosins).

The rosin derivative resin is typically a derivative of an aforementioned rosin. The term “rosin-based resin” as used herein is inclusive of derivatives of unmodified rosins and derivatives of modified rosins (including hydrogenated rosins, disproportionated rosins and polymerized rosins). Examples thereof include rosin esters such as unmodified rosin esters which are esters of unmodified rosins and alcohols, and modified rosin esters which are esters of modified rosins and alcohols; unsaturated fatty acid-modified rosins obtained by modification of rosins with unsaturated fatty acids; unsaturated fatty acid-modified rosin esters obtained by modification of rosin esters with unsaturated fatty acids; rosin alcohols obtained by reduction treatment of carboxy groups of rosins or various abovementioned rosin derivatives (including rosin esters, unsaturated fatty acid-modified rosins and unsaturated fatty acid-modified rosin esters); and metal salts of rosins or various abovementioned rosin derivatives. Specific examples of rosin esters include methyl esters, triethylene glycol esters, glycerin esters, and pentaerythritol esters of unmodified resins or modified rosins (hydrogenated rosins, disproportionated rosins, polymerized rosins, and the like).

Examples of the hydrocarbon-based tackifier resin include various hydrocarbon resins such as aliphatic hydrocarbon resins, aromatic hydrocarbon resins, aliphatic cyclic hydrocarbon resins, aliphatic/aromatic petroleum resins (styrene-olefin copolymers and the like), aliphatic/alicyclic petroleum resins, hydrogenated hydrocarbon resin, coumarone resins, and coumarone indene resins.

The softening point of the tackifier resin is not particularly limited. From the standpoint of improving the cohesiveness, in some embodiments, a tackifier resin having a softening point (softening temperature) of about 80° C. or higher (preferably, about 100° C. or higher) can be preferably used. The art disclosed herein can be preferably implemented in an embodiment in which more than 50% by weight (more preferably, more than 70% by weight, for example, more than 90% by weight) of the total amount of the tackifier resin (taken as 100% by weight) contained in the PSA layer is taken by a tackifier resin having the abovementioned softening point. For example, a phenolic tackifier resin (terpene phenolic resin or the like) having such a softening point can be advantageously used. The tackifier resin may include, for example, a terpene phenolic resin having a softening point of about 135° C. or higher (furthermore, about 140° C. or higher). The upper limit of the softening point of the tackifier resin is not particularly limited. From the standpoint of improving the adhesion to an adherend, in some embodiments, a tackifier resin having a softening point of about 200° C. or lower (more preferably about 80° C. or lower) can be preferably used. In some preferable embodiments, the tackifier resin (typically, a terpene-phenol resin) has a softening point below 130° C., for instance, about 120° C. or lower. For instance, such use of a tackifier resin having a relatively low softening point can improve the dispersibility of colorant such as a black colorant (typically, carbon black). The softening point of the tackifier resin can be measured based on a softening point test method (ring and ball method) prescribed in JIS K 2207.

In some preferable embodiments, the tackifier resin includes one or two or more phenolic tackifier resins (typically, a terpene phenolic resin). The art disclosed herein can be preferably implemented, for instance, in an embodiment where a terpene phenolic resin corresponds to about 25% by weight or more (more preferably, about 30% by weight or more) with the total amount of the tackifier resin being 100% by weight. About 50% by weight or more of the total amount of the tackifier resin may be a terpene phenolic resin, and about 80% by weight or more (e.g., about 90% by weight or more) may be a terpene phenolic resin. Substantially all of the tackifier resin (e.g., about 95% by weight to 100% by weight, even about 99% by weight to 100% by weight) may be a terpene phenolic resin.

While no particular limitations are imposed, in some embodiments, the tackifier resin may include a tackifier resin having a hydroxyl value higher than 20 mg KOH/g. Among such tackifier resins, a tackifier resin having a hydroxyl value of 30 mg KOH/g or more is preferable. Hereinafter, a tackifier resin having a hydroxyl value of 30 mg KOH/g or more may be referred to as a “high-hydroxyl-value resin”. With the tackifier resin including such a high-hydroxyl-value resin, a PSA layer can be obtained that shows excellent adhesion to the adherend and high cohesive strength. In some embodiments, the tackifier resin may include a high-hydroxyl-value resin having a hydroxyl value of 50 mg KOH/g or higher (more preferably, 70 mg KOH/g or higher). As the hydroxyl value, it is possible to use a value determined by the potentiometric titration method specified in JIS K0070:1992.

As the high-hydroxyl-value resin, a species having at least a prescribed hydroxyl value can be used among the various tackifier resins described earlier. The high-hydroxyl-value resins can be used singly as one species or in a combination of two or more species. For example, a phenolic tackifier resin having a hydroxyl value of 30 mgKOH/g or higher can be preferably used as the high-hydroxyl-value resin. In some preferable embodiments, a terpene phenolic resin having a hydroxyl value of 30 mgKOH/g or higher is used as the tackifier resin. The terpene phenolic resin is advantageous because the hydroxyl value can be controlled at will through the copolymerization ratio of phenol.

The maximum hydroxyl value of the high-hydroxyl-value resin is not particularly limited. From the standpoint of the compatibility with the base polymer and the like, the hydroxyl value of the high-hydroxyl-value resin is suitably about 200 mgKOH/g or lower, preferably about 180 mgKOH/g or lower, more preferably about 160 mgKOH/g or lower, and even more preferably about 140 mgKOH/g or lower. The art disclosed herein can be preferably implemented in an embodiment in which the tackifier resin includes a high-hydroxyl-value resin (e.g., a phenol-based tackifier resin, preferably a terpene phenolic resin) having a hydroxyl value of 30 mgKOH/g to 160 mgKOH/g. In some embodiments, a high-hydroxyl-value resin having a hydroxyl value of 30 mgKOH/g to 80 mgKOH/g (e.g., 30 mgKOH/g to 65 mgKOH/g) can be preferably used. In other embodiments, a high-hydroxyl-value resin having a hydroxyl value of 70 mgKOH/g to 140 mgKOH/g can be preferably used.

While no particular limitations are imposed, when a high-hydroxyl-value resin is used, the ratio of high-hydroxyl-value resin (e.g., a terpene phenolic resin) to the entire tackifier resin in the PSA layer can be, for example, about 25% by weight or higher, preferably about 30% by weight or higher, and more preferably about 50% by weight or higher (e.g., about 80% by weight or higher, typically about 90% by weight or higher). Substantially all of the tackifier resin (e.g., about 95% by weight to 100% by weight, more preferably about 99% by weight to 100% by weight) may be a high-hydroxyl-value resin.

When the PSA layer includes a tackifier resin, the amount of the tackifier resin used is not particularly limited, and may be suitably selected in a range of, for example, about 1 part to 100 parts by weight to 100 parts by weight of the base polymer. From the standpoint of favorably obtaining the effect to increase the peel strength, the amount of the tackifier resin used to 100 parts by weight of the base polymer (favorably an acrylic polymer) is suitably 5 parts by weight or greater, preferably 10 parts by weight or greater, or possibly 15 parts by weight or greater. For instance, in a colorant-containing PSA layer, the inclusion of a certain amount of tackifier resin (e.g., a terpene-phenol resin having a softening point of 120° C. or lower) tends to increase the dispersibility of colorant (e.g., carbon black). From the standpoint of the impact resistance and cohesive strength, the amount of the tackifier resin used to 100 parts by weight of the base polymer (favorably an acrylic polymer) is suitably 50 parts by weight or less, possibly 40 parts by weight or less, or even 30 parts by weight or less.

### (Crosslinking Agent)

In the art disclosed herein, the PSA composition used for forming the PSA layer may comprise a crosslinking agent as necessary. The type of crosslinking agent is not particularly limited and a suitable species can be selected and used among heretofore known crosslinking agents. Examples of the crosslinking agent include isocyanate-based crosslinking agents, epoxy-based crosslinking agents, oxazoline-based crosslinking agents, aziridine-based crosslinking agents, melamine-based crosslinking agents, peroxide-based crosslinking agents, urea-based crosslinking agents, metal alkoxide-based crosslinking agents, metal chelate-based crosslinking agents, metal salt-based crosslinking agents, carbodiimide-based crosslinking agents, hydrazine-based crosslinking agents, amine-based crosslinking agents, and silane coupling agents. Among them, isocyanate-based crosslinking agents, epoxy-based crosslinking agents, oxazoline-based crosslinking agents, aziridine-based crosslinking agents and melamine-based crosslinking agents are preferable; isocyanate-based crosslinking agents and epoxy-based crosslinking agents are more preferable; and isocyanate-based crosslinking agents are particularly preferable. The use of an isocyanate-based crosslinking agent tends to bring about impact resistance superior to other crosslinked matrices while obtaining the PSA layer's cohesive strength. For the crosslinking agent, solely one species or a combination of two or more species can be used.

As the isocyanate-based crosslinking agent, it is preferable to use a polyfunctional isocyanate (which refers to a compound having an average of two or more isocyanate groups per molecule, including a compound having an isocyanurate structure). For the isocyanate-based crosslinking agent, solely one species or a combination of two or more species can be used.

Examples of the polyfunctional isocyanate include aliphatic polyisocyanates, alicyclic polyisocyanates, and aromatic polyisocyanates.

Examples of an aliphatic polyisocyanate include 1,2-ethylene diisocyanate; tetramethylene diisocyanates such as 1,2-tetramethylene diisocyanate, 1,3-tetramethylene diisocyanate, 1,4-tetramethylene diisocyanate, etc.; hexamethylene diisocyanates such as 1,2-hexamethylene diisocyanate, 1,3-hexamethylene diisocyanate, 1,4-hexamethylene diisocyanate, 1,5-hexamethylene diisocyanate, 1,6-hexamethylene diisocyanate, 2,5-hexamethylene diisocyanate, etc.; 2-methyl-1,5-pentane diisocyanate, 3-methyl-1,5-pentane diisocyanate, and lysine diisocyanate.

Examples of an alicyclic polyisocyanate include isophorone diisocyanate; cyclohexyl diisocyanates such as 1,2-cyclohexyl diisocyanate, 1,3-cyclohexyl diisocyanate, 1,4-cyclohexyl diisocyanate, etc.; cyclopentyl diisocyanates such as 1,2-cyclopentyl diisocyanate, 1,3-cyclopentyl diisocyanate etc.; hydrogenated xylylene diisocyanate, hydrogenated tolylene diisocyanate, hydrogenated diphenylmethane diisocyanate, hydrogenated tetramethylxylene diisocyanate, and 4,4′-dicyclohexylmethane diisocyanate.

Examples of an aromatic polyisocyanate include 2,4-tolylene diisocyanate, 2,6-tolylene diisocyanate, 4,4′-diphenylmethane diisocyanate, 2,4′-diphenylmethane diisocyanate, 2,2′-diphenylmethane diisocyanate, 4,4′-diphenylether diisocyanate, 2-nitrodiphenyl-4,4′-diisocyanate, 2,2′-diphenylpropane-4,4′-diisocyanate, 3,3′-dimethyldiphenylmethane-4,4′-diisocyanate, 4,4′-diphenylpropane diisocyanate, m-phenylene diisocyanate, p-phenylene diisocyanate, naphthylene-1,4-diisocyanate, naphthylene-1,5-diisocyanate, 3,3′-dimethoxydiphenyl-4,4′-diisocyanate, xylylene-1,4-diisocyanate, and xylylene-1,3-diisocyanate.

A preferable example of the polyfunctional isocyanate has an average of three or more isocyanate groups per molecule. Such a tri-functional or higher polyfunctional isocyanate can be a multimer (typically a dimer or a trimer), a derivative (e.g., an adduct of a polyol and two or more polyfunctional isocyanate molecules), a polymer or the like of a di-functional, tri-functional, or higher polyfunctional isocyanate. Examples include polyfunctional isocyanates such as a dimer and a trimer of a diphenylmethane diisocyanate, an isocyanurate (a cyclic trimer) of a hexamethylene diisocyanate, a reaction product of trimethylol propane and a tolylene diisocyanate, a reaction product of trimethylol propane and a hexamethylene diisocyanate, polymethylene polyphenyl isocyanate, polyether polyisocyanate, and polyester polyisocyanate. Commercially available polyfunctional isocyanates include product name DURANATE TPA-100 available from Asahi Kasei Chemicals Corporation and product names CORONATE L, CORONATE HL, CORONATE HK, CORONATE HX and CORONATE 2096 available from Tosoh Corporation.

The amount of isocyanate-based crosslinking agent used is not particularly limited. For example, it can be about 0.5 part by weight or greater to 100 parts by weight of the base polymer (favorably an acrylic polymer). From the standpoint of combining cohesive strength with tightness of adhesion and of the impact resistance and so on, the amount of isocyanate-based crosslinking agent used to 100 parts by weight of the base polymer may be, for example, 1.0 part by weight or greater, or preferably 1.5 parts by weight or greater (typically 2.0 parts by weight or greater, e.g., 2.5 parts by weight or greater). From the standpoint of obtaining tighter adhesion to the adherend, the amount of the isocyanate-based crosslinking agent used is suitably 10 parts by weight or less, 8 parts by weight or less, or even 5 parts by weight or less (e.g., 3 parts by weight or less) to 100 parts by weight of the base polymer.

In some preferable embodiments, as the crosslinking agent, an isocyanate-based crosslinking agent is used in combination with at least one other species of crosslinking agent having a crosslinkable functional group different from that of the isocyanate-based crosslinking agent (or a “non-isocyanate-based crosslinking agent). According to the art disclosed herein, the combined use of isocyanate-based crosslinking agent and non-isocyanate-based crosslinking agent can bring about excellent cohesive strength. For instance, it can favorably combine high heat-resistant cohesive strength and excellent metal corrosion inhibition in an embodiment comprising a rust inhibitor such as azole-based rust inhibitor. The PSA layer in the art disclosed herein may include the crosslinking agent, for instance, in a crosslinked form, in a pre-crosslinked form, in a partially crosslinked form, in an intermediate or combined form of these. In typical, the crosslinking agent is included in the adhesive layer mostly in a crosslinked form.

There are no particular limitations to the type of non-isocyanate-based crosslinking agent that can be used in combination with the isocyanate-based crosslinking agent. A suitable species can be selected and used among the crosslinking agents described above. The non-isocyanate-based crosslinking agents can be used singly as one species or in a combination of two or more species.

In some preferable embodiments, an epoxy-based crosslinking agent can be used as the non-isocyanate-based crosslinking agent. For instance, with the combined use of isocyanate-based and epoxy-based crosslinking agents, cohesion is likely to be combined with impact resistance. As the epoxy-based crosslinking agent, a compound having two or more epoxy groups in a molecule can be used without particular limitation. An epoxy-based crosslinking agent having 3 to 5 epoxy groups in a molecule is preferable. Epoxy-based crosslinking agents can be used singly as one species or in a combination of two or more species.

Specific examples of the epoxy-based crosslinking agent include, but are not limited to, N,N,N′,N′-tetraglycidyl-m-xylenediamine, 1,3-bis(N,N-diglycidylaminomethyl)cyclohexane, 1,6-hexanediol diglycidyl ether, polyethylene glycol diglycidyl ether, and polyglycerol polyglycidyl ether. Examples of commercially available epoxy-based crosslinking agents include product names TETRAD-C and TETRAD-X both available from Mitsubishi Gas Chemical Co., Inc., product name EPICLON CR-5L available from DIC Corp., product name DENACOL EX-512 available from Nagase ChemteX Corporation, and product name TEPIC-G available from Nissan Chemical Industries, Ltd.

The amount of the epoxy-based crosslinking agent to be used is not particularly limited. The amount of the epoxy-based crosslinking agent to be used can be, for example, more than 0 part by weight and about 1 part by weight or less (typically about 0.001 part to 0.5 part by weight) to 100 parts by weight of the base polymer (favorably an acrylic polymer). From the standpoint of favorably obtaining the effect to increase the cohesive strength, the amount of epoxy-based crosslinking agent used is suitably about 0.002 part by weight or greater, preferably about 0.005 part by weight or greater, or more preferably about 0.008 part by weight or greater to 100 parts by weight of the base polymer. From the standpoint of obtaining tighter adhesion to an adherend, the amount of the epoxy-based crosslinking agent used is suitably about 0.2 part by weight or less, preferably about 0.1 part by weight or less, more preferably less than about 0.05 part by weight, or even more preferably less than about 0.03 part by weight (e.g., about 0.025 part by weight or less) to 100 parts by weight of the base polymer. With decreasing amount of epoxy-based crosslinking agent used, the impact resistance tends to improve.

In the art disclosed herein, the relative amounts of isocyanate-based crosslinking agent and non-isocyanate-based crosslinking agent (e.g., epoxy-based crosslinking agent) are not particularly limited. For instance, the amount of non-isocyanate-based crosslinking agent can be about 1/50 or less of the amount of isocyanate-based crosslinking agent. From the standpoint of more favorably bringing about tight adhesion to the adherend and cohesive strength, the amount of non-isocyanate-based crosslinking agent is suitably about 1/75 or less, or preferably about 1/100 or less (e.g., 1/150 or less) of the amount of isocyanate-based crosslinking agent by weight. From the standpoint of favorably obtaining the effect of the combined use of isocyanate-based crosslinking agent and non-isocyanate-based crosslinking agent (e.g., epoxy-based crosslinking agent), the amount of the non-isocyanate-based crosslinking agent is suitably about 1/1000 or more, for example, about 1/500 or more of the amount of isocyanate-based crosslinking agent.

The total use (total amount) of crosslinking agent is not particularly limited. For instance, it can be about 10 parts by weight or less to 100 parts by weight of the base polymer (favorably an acrylic polymer) or selected from a range of preferably about 0.005 part to 10 parts by weight, or more preferably about 0.01 part to 5 parts by weight.

### (Rust Inhibitor)

The PSA layer according to some preferable embodiments may include a rust inhibitor. As the rust inhibitor, an azole-based rust inhibitor can be preferably used. The rust-inhibitor-containing PSA layer is preferable in a case that requires metal corrosion inhibition such as when applied to a metal. A preferable azole-based rust inhibitor comprises an azole-based compound (a five-membered cyclic aromatic compound having two or more hetero atoms with at least one of which being a nitrogen atom) as an active ingredient. For the rust inhibitor, solely one species or a combination of two or more species can be used.

Examples of the azole-based compound include azoles such as imidazole, pyrazole, oxazole, isoxazole, thiazole, isothiazole, selenazole, 1,2,3-triazole, 1,2,4-triazole, 1,2,5-oxadiazole, 1,3,4-oxadiazole, 1,2,3-thiadiazole, 1,2,4-thiadiazole, 1,3,4-thiadiazole, tetrazole, and 1,2,3,4-thiatriazole; derivatives thereof, amine salts thereof; and metal salts thereof. Examples of azole derivatives include compounds having a structure including a condensed ring of an azole ring and another ring such as a benzene ring. Specific examples thereof include indazole, benzimidazole, benzotriazole (that is, 1,2,3-benzotriazole having a structure in which an azole ring of 1,2,3-triazole is condensed with a benzene ring), and benzothiazole, and derivatives thereof such as alkylbenzotriazoles (e.g., 5-methylbenzotriazole, 5-ethylbenzotriazole, 5-n-propylbenzotriazole, 5-isobutylbenzotriazole, and 4-methylbenzotriazole), alkoxybenzotriazoles (e.g., 5-methoxybenzotriazole), alkylaminobenzotriazoles, alkylaminosulfonylbenzotriazoles, mercaptobenzotriazole, hydroxybenzotriazole, nitrobenzotriazoles (e.g., 4-nitrobenzotriazole), halobenzotriazoles (e.g., 5-chlorobenzotriazole), hydroxyalkylbenzotriazoles, hydroxybenzotriazoles, aminobenzotriazoles, (substituted aminomethyl)-tolyltriazoles, carboxybenzotriazole, N-alkylbenzotriazoles, bisbenzotriazoles, naphthotriazoles, mercaptobenzothiazole, and aminobenzthiazole, amine salts thereof, and metal salts thereof. Other examples of azole derivatives include an azole derivative having a non-condensed ring structure, for example, compounds with a structure having a substituent on a non-condensed azole ring, for example, 3-amino-1,2,4-triazole and 5-phenyl-H-tetrazole. The azole compounds can be used singly as one species or in a combination of two or more species.

Preferable examples of compounds that can be used as the azole-based rust inhibitor include benzotriazole-based rust inhibitors including a benzotriazole compound as an active ingredient. The art disclosed herein can be preferably implemented, for example, in an embodiment in which the base polymer is an acrylic polymer and the rust inhibitor is a benzotriazole-based rust inhibitor. In such an embodiment, a PSA sheet can be favorably obtained that provides satisfactory metal corrosion inhibition and excellent holding properties. Favorable examples of the benzotriazole-based compound include 1,2,3-benzotriazole, 5-methylbenzotriazole, 4-methylbenzotriazole, and carboxybenzotriazole.

Examples of the non-azole-based rust inhibitor possibly in the PSA layer disclosed herein are not particularly limited. Examples include amine compounds, nitrites, ammonium benzoate, ammonium phthalate, ammonium stearate, ammonium palmitate, ammonium oleate, ammonium carbonate, salts of dicyclohexylaminebenzoic acid, urea, urotropin, thiourea, phenyl carbamate, and cyclohexylammonium-N-cyclohexyl carbamate (CHC). These rust inhibitors which are not azole compounds (non-azole-based rust inhibitors) can be used singly as one species or in a combination of two or more species. Alternatively, the art disclosed herein can also preferably be implemented in an embodiment essentially free of non-azole-based rust inhibitor.

The amount of the rust inhibitor (favorably an azole-based rust inhibitor, e.g., a benzotriazole-based rust inhibitor) is not particularly limited, and can be, for example, 0.01 part by weight or greater (typically 0.05 parts by weight or greater) to 100 parts by weight of the base polymer. From the standpoint of obtaining greater inhibition of metal corrosion, the amount may be 0.1 part by weight or greater, 0.3 part by weight or greater, or 0.5 part by weight or greater. On the other hand, from the standpoint of increasing the cohesive strength (e.g., heat-resistant cohesive strength) of the PSA, the amount of azole-based rust inhibitor to 100 parts by weight of base polymer is suitably less than 8 parts by weight, preferably 5 parts by weight or less, possibly 3 parts by weight or less, or even 1 part by weight or less (e.g., 0.6 part by weight or less).

### (Non-Black Colorant)

The PSA layer may comprise a non-black colorant (a colorant other than black colorants) as far as the effect of the art disclosed herein is not impaired. The non-black colorant may have a color of, for instance, white, red, blue, yellow, green, yellow-green, orange, purple, gold and silver. As the non-black colorant, heretofore known pigments and dyes can be used. As the pigments, both inorganic and organic pigments can be used. As the inorganic pigment, a suitable species can be selected and used among, for instance, zinc carbonate, zinc oxide, zinc sulfide, talc, kaolin, calcium carbonate, titanium oxide, silica, lithium fluoride, calcium fluoride, barium sulfate, alumina, zirconia, iron oxides, iron hydroxides, aluminum hydroxide, calcium hydroxide, magnesium hydroxide, chromium oxides, calcined spinels, chromic acids, chromium vermilions, iron blues, aluminum powders, bronze powders, silver powders, and calcium phosphate. As the organic pigments, a suitable species can be selected and used among phthalocyanine-based, azo-based, condensed azo-based, azo lake-based, anthraquinone-based, perylene-perinone-based, indigo-based, thioindigo-based, isoindolinone-based, azomethine-based, dioxazine-based, quinacridone-based, aniline black-based, and triphenylmethane-based kinds. As the dyes, a suitable species can be selected and used among, for instance, azo-based dyes, anthraquinone, quinophthalone, styryl, diphenylmethane, triphenylmethane, oxazine, triazine, xanthan, methane, azomethine, acridine, and diazine. The non-black colorants can be used singly as one species or in a suitable combination of two or more species.

The non-black colorant content in the PSA layer is not particularly limited. It is, for instance, possibly below 13% by weight, preferably below 10% by weight, also possibly, for instance, below 5% by weight, or even below 3.0% by weight (e.g., below 2.0% by weight, or even below 1% by weight). The art disclosed herein can be preferably implemented in an embodiment in which the PSA layer is essentially free of a non-black colorant.

### (Other Additives)

The PSA composition may include, as necessary, various additives which are common in the field of PSA compositions, such as a leveling agent, crosslinking aid, plasticizer, softener, antistatic agent, aging-preventing agent, UV absorber, antioxidant, and light stabilizer. As for these various additives, heretofore known species can be used by conventional methods, and the present invention is not particularly characterized thereby. Therefore, detailed description is omitted.

### (PSA Composition)

The PSA layer disclosed herein can be formed from an aqueous PSA composition, solvent-based PSA composition, hot-melt PSA composition, or active energy my-curable PSA composition. The aqueous PSA composition refers to a PSA composition that comprises a PSA (PSA layer-forming components) in a solvent whose primary component is water (an aqueous solvent), typically including a so-called water-dispersed PSA composition (in which the PSA is at least partially dispersed in water). Further, the solvent-based PSA composition refers to a PSA composition that comprises a PSA in an organic solvent. As the organic solvent in the solvent-based PSA composition, among the examples (toluene, ethyl acetate, etc.) of the organ solvent possibly used in the solution polymerization, one, two or more species can be used without particular limitations. From the standpoint of adhesive properties and the like, the art disclosed herein can be preferably implemented in an embodiment in which the PSA layer is formed from a solvent-based PSA composition.

### (Formation of PSA Layer)

The PSA layer disclosed herein can be formed by a conventionally known method. For instance, it is possible to use a method where a PSA composition is applied to a releasable surface (release face) and allowed to dry to form a PSA layer. For example, in an embodiment of the PSA sheet having a substrate, a direct method can be used where the PSA composition is directly provided (typically applied) to the substrate and allowed to dry to form a PSA layer. Alternatively, a transfer method can be employed where the PSA composition is provided to a releasable surface (e.g., a release face) and allowed to dry to form a PSA layer on the surface and the PSA layer is transferred to a substrate. As the release face, the surface of a release liner described later can be preferably used. The PSA layer disclosed herein is typically formed in a continuous form, but not limited to such a form. For instance, the PSA layer may be formed in a regular or random pattern of dots, stripes, etc.

The PSA composition can be applied with a heretofore known coater, for instance, a gravure roll coater, die coater, and bar coater. Alternatively, the PSA composition can be applied by immersion, curtain coating, etc.

From the standpoints of accelerating the crosslinking reaction, improving production efficiency, and the like, it is preferable to dry the PSA composition under heating. The drying temperature can be, for example, about 40° C. to 150° C., and preferably about 60° C. to 130° C. After dried, the PSA composition can be subjected to aging to adjust the distribution or migration of components within the PSA layer, to allow the crosslinking reaction to proceed, to reduce possible distortion in the substrate and the PSA layer, and so on.

The PSA layer disclosed herein may have a monolayer structure or a multilayer structure with two or more layers. From the standpoint of the productivity, etc., the PSA layer preferably has a monolayer structure.

The thickness of the PSA layer is not particularly limited. From the standpoint of preventing the PSA sheet from becoming excessively thick, the thickness of the PSA layer is, for instance, about 300 μm or less, suitably about 100 μm or less, preferably about 70 μm or less, and more preferably about 50 μm or less (e.g., about 30 μm or less). In some preferable embodiments, the PSA layer thickness can be about 35 μm or less, for instance, about 25 μm or less, even about 15 μm or less. In some embodiments, the PSA layer has a thickness of about 10 μm or less, possibly about 7 μm or less, or even about 5 μm or less (e.g., about 3 μm or less). The PSA layer with a limited thickness may well accommodate needs for thinning and weight saving. The art disclosed herein can bring about improved IR-blocking properties in an embodiment having such a thin PSA layer. It is noted that with decreasing PSA layer thickness, the thickness-direction light-blocking properties will degrade, but the in-plane-direction light transmittance will be less likely to be problematic.

The minimum thickness of the PSA layer is not particularly limited. From the standpoint of the tightness of adhesion to an adherend, it is advantageously about 1 μm or greater, suitably about 3 μm or greater, preferably about 5 μm or greater, more preferably about 7 μm or greater, or yet more preferably about 12 μm or greater (e.g., about 15 μm or greater). This can further enhance the IR-blocking properties (especially the thickness-direction light-blocking properties). In some embodiments, the PSA layer thickness is greater than 20 μm, possibly greater than 30 μm, greater than 40 μm, or even greater than 50 μm (e.g., greater than 60 μm). For instance, in a substrate-free double-faced PSA sheet, such a thickness can be preferably used. When the PSA sheet disclosed herein is made in an embodiment having first and second PSA layers, the first and second PSA layers may have the same or different thicknesses.

### <Substrate Layer>

In an embodiment of the PSA sheet disclosed herein as an adhesively single-faced or double-faced substrate-supported PSA sheet, as the substrate (also “substrate layer” or “support substrate”; the same applies hereinafter unless otherwise noted) supporting (backing) the PSA layer(s), it is possible to use a resin film, paper, cloth, rubber sheet, foam sheet, metal foil, composite of these, etc. Examples of the resin film include polyolefinic resin film such as polyethylene (PE), polypropylene (PP), and an ethylene-propylene copolymer; polyester-based resin film such as polyethylene terephthalate (PET), polybutylene terephthalate (PBT), and polyethylene naphthalate (PEN); vinyl chloride resin film; vinyl acetate resin film; polyimide resin film; polyamide resin film; fluororesin film; and cellophane. The resin film can be a rubber-based film such as natural rubber film and butyl rubber film. Examples of the paper include Washi paper, kraft paper, glassine paper, high-grade paper, synthetic paper and top-coated paper. Examples of the cloth include woven fabrics and non-woven fabrics formed of one species or a blend of various fibrous substances. Examples of the fibrous substances include cotton, staple fiber, Manila hemp, pulp, rayon, acetate fiber, polyester fiber, polyvinyl alcohol fiber, polyamide fiber and polyolefin fiber. Examples of the rubber sheet include a natural rubber sheet and a butyl rubber sheet. Examples of the foam sheet include a polyurethane foam sheet and a polychloroprene rubber foam sheet. Examples of the metal foil include aluminum foil and copper foil.

As the substrate forming the substrate-supported PSA sheet, it is preferable to use a substrate comprising a resin film as the base film. The resin film comprises a resin material as the primary component (e.g., a component accounting for more than 50% by weight of the resin film) and may be formed from one, two or more species of resin film materials among the examples shown above. In particular, from the standpoint of the handling properties and the ease of processing, polyester films are preferable and among them PET film is particularly preferable. The PSA sheet having a resin film substrate can be processed by punching, etc., with good precision. Such a PSA sheet is preferable for applications where it is used after processed to have a specific shape or a narrow width. The base film is typically a component capable of maintaining the shape by itself (a self-standing member). The substrate in the art disclosed herein may be essentially formed of such a base film. Alternatively, the substrate may include a supplemental layer in addition to the base film. Examples of the supplemental layer include a colored layer, a reflective layer, a primer layer and an anti-static layer formed on the surface of the base film.

As used herein, the “resin film” typically refers to a non-porous sheet and should be conceptually distinguished from so-called non-woven and woven fabrics (i.e., the concept excludes non-woven and woven fabrics). The resin film can be an unstretched film, uniaxially-stretched film or biaxially-stretched film. The concept of nonwoven fabric here primarily refers to non-woven fabric for PSA sheets used in the field of PSA tape and other PSA sheets, typically referring to nonwoven fabric (or so-called “paper”) fabricated using a general paper machine.

In typical, the substrate preferably includes a black colorant. The use of the black colorant-containing substrate preferably brings about excellent IR-blocking properties. In some preferably embodiments, the substrate is a substrate film comprising a black colorant, more specifically, a substrate film (typically a resin film) in which the black colorant is compounded. Here, the substrate film in which a black colorant is compounded refers to a substrate film such that a black colorant is mixed in the primary material (the material accounting the highest content of the substrate film, typically a resin material) forming the substrate film. The black colorant is substantially dispersed in the substrate film. There are no particular limitations to the state of dispersion of the black colorant in the substrate film. The black colorant is preferably dispersed in the substrate film to a degree where the substrate film's thickness-direction IR transmittance is at or below a certain value (e.g. at or below 5%). With the use of the black colorant-containing substrate film, the PSA sheet can preferably bring about excellent IR-blocking properties. The black colorant-containing substrate film has an advantage in terms of precision of processing because the substrate film (typically a resin film) has superior rigidity with the relatively large thickness as compared to a substrate film that has a laminate structure formed of a resin film and a conventional colored layer (printed layer) that has a comparable thickness to the substrate film. As a colored layer is no longer necessary, the PSA layer can be made thicker by that much, making it more likely to maintain good adhesive properties. It is noted that, in other words, the black colorant-containing substrate film itself is colored black and can be referred to as a black substrate film.

As the black colorant in the substrate, organic and inorganic colorants (pigments, dyes, etc.) can be used. Specific examples of the black colorant include carbon blacks (furnace black, channel black, acetylene black, thermal black, lamp black, turpentine soot, etc.), graphite, copper oxide, manganese(IV) oxide, aniline black, perylene black, titanium black, cyanine black, activated carbon, ferrites (non-magnetic ferrite, magnetic ferrite, etc.), magnetite, chromium oxide, iron oxide, molybdenum disulfide, chromium complexes, and anthraquinone-based colorants. Among them, carbon black is preferable. For the black colorant, solely one species or a combination of two or more species can be used.

The black colorant in the substrate is not particularly limited. A particulate colorant (pigment) can be preferably used because it can enhance the IR-blocking properties in a small amount. In some preferable embodiments, a black colorant (e.g., a black pigment such as carbon black) having a mean particle diameter of about 10 nm or larger (e.g., about 50 nm or larger) can be used. The maximum mean particle diameter of the black colorant is not particularly limited. For instance, it is about 500 nm or less, preferably about 300 nm or less, or more preferably about 250 nm or less, for instance, possibly 200 nm or less (e.g., about 120 nm or less).

The amount of black colorant (e.g., carbon black) used in the substrate (e.g., resin film) is not particularly limited. It can be used in an amount suitably adjusted to provide desirable optical properties. The black colorant content is possibly 0.1% or more of the weight of the substrate, suitably about 0.5% by weight or more, also possibly about 1% by weight or more (e.g., above 1% by weight), or even 2% by weight or more (e.g., above 2% by weight). In some preferable embodiments, from the standpoint of enhancing the IR-blocking properties, the black colorant content is about 3% by weight or more, more preferably about 4% by weight or more, possibly about 5% by weight or more (e.g., about 6% by weight or more), about 8% by weight or more, or even about 10% by weight or more. For instance, such a black colorant content is likely to bring about excellent IR-blocking properties even in an embodiment with a thin substrate. In view of the substrate's mechanical properties, ease of molding, etc., the black colorant content of the substrate is, for instance, about 30% by weight or less, possibly about 25% by weight or less, or suitably about 20% by weight or less. In some preferable embodiments, the black colorant content of the substrate is about 15% by weight or less, preferably about 12% by weight or less, yet more preferably about 8% by weight or less, for instance, possibly about 6% by weight or less, about 4% by weight or less, or even about 2% by weight or less (e.g., below 1% by weight).

The substrate disclosed herein may include a colorant (pigment or dye) other than a black colorant. As such a non-black colorant, it is possible to use one, two or more species among the examples of non-black colorants that can be included in the PSA layer. The amount of non-black colorant used in the substrate is not particularly limited. It can be used in an amount suitably adjusted to provide desirable optical properties. Of the substrate weight, the amount of non-black colorant is suitably about 30% by weight or less (0 to 30% by weight), possibly below 10% by weight (e.g., 0.1% or greater and below 10% by weight), or even below 3% by weight (e.g., below 1% by weight). The art disclosed herein can be preferably implemented in an embodiment where the substrate is essentially free of a non-black colorant.

To the substrate (e.g., resin film), various additives can be added as necessary, such as fillers (inorganic and organic fillers, etc.), dispersing agent (surfactant, etc.), anti-aging agent, antioxidant, UV absorber, anti-static agent, slip agent and plasticizer. These various additives are added in amounts equivalent to about less than 30% by weight (e.g., less than 20% by weight, typically less than 10% by weight).

The substrate (e.g., resin film) may have a monolayer structure or a multilayer structure with two, three or more layers. From the standpoint of the shape stability, the substrate preferably has a monolayer structure. In case of a multilayer structure, at least one layer (preferably each layer) preferably has a continuous structure formed of the resin (e.g., a polyester-based resin). The method for producing the substrate (typically a resin film) is not particularly limited and a heretofore known method can be suitably employed. For instance, heretofore known general film-forming methods can be suitably employed, such as extrusion, inflation molding, T-die casting, and calendar rolling.

The substrate can be colored with a colored layer placed on the surface of the base film (preferably a resin film). In the support substrate in such an embodiment including the base film and colored layer, the base film may or may not include a colorant. The colored layer can be placed on one or each face of the base film. In an embodiment having a colored layer on each face of the base film, the respective colored layers may be the same or different in constitution.

Such a colored layer can be typically formed by applying a colored layer-forming composition to a base film, the composition comprising a colorant and a binder. As the colorant, heretofore known pigments and dyes can be used, similar to the colorants that can be included in the PSA layer and resin film. As the binder, materials known in the paint or printing field can be used without particular limitations. Examples include polyurethane, phenol resin, epoxy resin, urea-melamine resin and polymethyl methacrylate. The colored layer-forming composition can be, for instance, a solvent-based type, UV-curable type, heat-curable type, etc. The colored layer can be formed by a conventional colored layer-forming method without particular limitations. For instance, it is preferable to use a method where the colored layer (printed layer) is formed by gravure printing, flexographic printing, offset printing, etc.

The colored layer may have a monolayer structure formed entirely of a single layer or a multilayer structure including two, three or more colored sublayers. For instance, a colored layer having a multilayer structure with two or more colored sublayers can be formed by repeated applications (e.g., printing) of a colored layer-forming composition. The respective colored sublayers may be the same or different in color and amount of colorant. In a colored layer to provide light-blocking properties, from the standpoint of preventing formation of pinholes to increase the reliability of light leakage prevention, a multilayer structure is particularly significant.

The colored layer has a total thickness of suitably about 1 μm to 10 μm, preferably about 1 μm to 7 μm, or possibly, for instance, about 1 μm to 5 μm. In the colored layer including two or more colored sublayers, each sublayer preferably has a thickness of about 1 μm to 2 μm.

The substrate surface may be subjected to heretofore known surface treatments such as corona discharge treatment, plasma treatment, UV irradiation, acid treatment, base treatment, and primer coating. Such a surface treatment may increase the tightness of adhesion between the substrate and the PSA layer. In other words, it may improve the anchoring of the PSA layer to the substrate.

When the art disclosed herein is made as a substrate-supported adhesively single-faced PSA sheet, the backside of the substrate may be subjected to a release treatment as necessary. In the release treatment, for instance, a general silicone-based, long-chain alkyl-based or fluorine-based release agent is applied typically in a thin layer measuring about 0.01 μm to 1 μm (e.g., 0.01 μm to 0.1 μm). Such a release treatment can be provided to bring about easier unwinding of a roll formed by winding the PSA sheet and other effects.

In an embodiment of the PSA sheet having a substrate, the substrate preferably has a thickness-direction light transmittance in 780-2500 nm wavelength region of 5% or lower. With the use of a substrate satisfying this property, it is possible to obtain a PSA sheet having excellent IR-blocking properties. The substrate's thickness-direction IR transmittance is, for instance, 3% or lower, or suitably 1% or lower. From the standpoint of the IR-blocking properties, the substrate's thickness-direction IR transmittance is preferably 0.50% or lower, more preferably 0.30% or lower, yet more preferably 0.10% or lower, particularly preferably 0.03% or lower, or most preferably 0.01% or lower (e.g., below 0.01%). The minimum IR transmittance can be essentially 0% (i.e., at or below detection limit) or 0.01% (e.g., 0.001%). In other embodiments, in relation to the PSA layer's light-blocking properties, it may be unnecessary to greatly lower the substrate's IR transmittance. In such a case, it is significant that the substrate has at least a certain IR transmittance from industrial perspectives including retention of substrate properties (processability, mechanical properties), productivity and efficiency. From such standpoints, the substrate's IR transmittance can be above 0.01% (e.g., above 0.05%), above 0.1%, or even about 1.0% or higher.

In an embodiment of the PSA sheet having a substrate, the substrate preferably has a limited thickness-direction light transmittance in 380-780 nm wavelength region. A substrate having a low VIS transmittance is suited as a PSA sheet for light-blocking purposes. The substrate's thickness-direction VIS transmittance is, for instance, 1% or lower, suitably 0.3% or lower, possibly 0.1% or lower, or even 0.03% or lower. From the standpoint of the light-blocking properties, the substrate according to some embodiments has a thickness-direction VIS transmittance of 0.01% or lower (e.g., below 0.01%). The minimum VIS transmittance can be essentially 0% (i.e., at or below detection limit), for instance, 0.01% (e.g., 0.001%). In other embodiments, in relation to the PSA layer's light-blocking properties, it may be unnecessary to greatly lower the substrate's VIS transmittance. In such a case, it is significant that the substrate has at least a certain VIS transmittance from industrial perspectives including retention of substrate properties (processability, mechanical properties), productivity and efficiency. From such standpoints, the substrate's VIS transmittance can be above 0.01% (e.g., above 0.05%), above 0.1%, or even about 1.0% or higher.

The IR transmittance and VIS transmittance can be adjusted by suitably selecting components (typically, a species of black colorant and its amount) included in the substrate based on the content of this Description. The substrate's IR transmittance and VIS transmittance can be determined by the same methods as the PSA sheet's thickness-direction light transmittance measurement method described later in Examples. While no particular limitations are imposed, in a black colorant-containing substrate, the in-plane-direction light transmittance of a substrate is typically lower than its thickness-direction light transmittance.

The substrate thickness is not particularly limited. The substrate thickness is, for instance, about 500 μm or less. From the standpoint of avoiding too thick a PSA sheet, it can be about 200 μm or less (e.g., about 150 μm or less), or even about 100 μm or less. In some embodiments, the substrate thickness is less than 75 μm, or possibly about 70 μm or less. The substrate with a limited thickness is preferably used for applications requiring thinning and weight reduction. For instance, by limiting the substrate thickness to make a relatively thick PSA layer, the adhesive properties such as peel strength and impact resistance can be increased. From such a standpoint, further in accordance with the purpose and application of the PSA sheet, the substrate thickness is preferably about 50 μm or less, possibly about 30 μm or less, about 25 μm or less, or even about 20 μm or less. The art disclosed herein can bring about improved IR-blocking properties in an embodiment having such a thin substrate. In some embodiments, the substrate thickness is about 15 μm or less, possibly about 12 μm or less (e.g., less than 12 μm), about 10 μm or less, or even about 7 μm or less.

From the standpoints of the handling properties and ease of processing of the PSA sheet, the substrate thickness is, for instance, 0.5 μm or greater (e.g., 1 μm or greater), suitably about 2 μm or greater, preferably about 5 μm or greater (e.g., greater than 5 μm), more preferably about 10 μm or greater, possibly about 14 μm or greater, about 18 μm or greater, or even 22 μm or greater. For instance, in an embodiment having a black colorant-containing substrate, such a substrate thickness is likely to bring about excellent IR-blocking properties. In other embodiments, the substrate thickness is, for instance, 40 μm or greater, or greater than 50 μm. For instance, in an embodiment having a black colorant-containing substrate, when the substrate is thicker than 50 μm, the IR-blocking properties can be effectively enhanced. In this embodiment, the substrate thickness can be 75 μm or greater, or even 90 μm or greater (e.g., 120 μm or greater).

In an embodiment of the PSA sheet having a substrate, the ratio of substrate thickness in the total PSA sheet thickness is not particularly limited. From the standpoint of benefitting from the substrate properties (mechanical properties, optical properties), the ratio of substrate thickness in the total PSA sheet thickness is, for instance, 10% or higher, possibly 20% or higher, or suitably 30% or higher. In some preferable embodiments, the ratio of substrate thickness in the total PSA sheet thickness is 40% or higher, more preferably 50% or higher, yet more preferably 60% or higher, or possibly 70% or higher (e.g., 80% or higher). With such a constitution, for instance, in an embodiment having a black colorant-containing substrate, excellent IR-blocking properties are likely to be obtained. This constitution can be an advantageous feature in a thin PSA sheet with a limited thickness. From the standpoint of the adhesive properties, impact resistance, etc., the ratio of substrate thickness in the total PSA sheet thickness is, for instance, 90% or lower, suitably 80% or lower, preferably 65% or lower, or possibly 55% or lower. In some embodiments, the ratio of substrate thickness in the total PSA sheet thickness can be 35% or lower, or even 25% or lower.

### <Release Liner>

In the art disclosed herein, a release liner can be used in formation of the PSA layer, preparation of the PSA sheet, storage, distribution and processing of the unused PSA sheet, etc. The release liner is not particularly limited, and examples thereof include a release liner having a release layer on the surface of a liner substrate such as a resin film (polyester (e.g., PET) film, etc.) or paper, and a release liner made of a low-adhesive material such as a fluoropolymer (polytetrafluoroethylene, etc.) or a polyolefin resin (polyethylene, polypropylene, etc.). The release layer can be formed, for example, by subjecting the liner substrate to surface treatment with a release agent such as a silicone-based, long-chain alkyl-based, fluorine-based agent kind, or molybdenum sulfide. The release liner thickness is not particularly limited and can be about 10 μm to 500 μm (e.g., 15 μm to 300 μm).

### <Total PSA Sheet Thickness>

The total thickness of the PSA sheet disclosed herein (including PSA layer(s) and a substrate if any, but not a release liner) is not particularly limited. The total PSA sheet thickness is, for instance, about 1 mm or less, or possibly about 300 μm or less. From the standpoint of thickness reduction, it is suitably about 200 μm or less, or possibly even about 100 μm or less (e.g., about 70 μm or less). The minimum PSA sheet thickness is not particularly limited. It is, for instance, suitably about 3 μm or greater, preferably about 6 μm or greater, or more preferably about 10 μm or greater (e.g., about 15 μm or greater). The PSA sheet having at least a certain thickness is easily handled and tends to provide superior adhesion and impact resistance. It is noted that in a substrate-free PSA sheet, the PSA layer thickness is the total PSA sheet thickness.

In some embodiments, the PSA sheet thickness is less than 75 μm. In these embodiments, the PSA sheet thickness can be about 50 μm or less (e.g., below 50 μm), for instance, about 35 μm or less, or even about 25 μm or less. According to the art disclosed herein, excellent IR-blocking properties can be obtained even in such a thin embodiment. The minimum PSA sheet thickness can be about 5 m or greater (e.g., above 5 μm). From the standpoint of the light-blocking properties and adhesive properties such as adhesive strength, it is suitably about 10 μm or greater (e.g., above 10 μm), preferably about 16 μm or greater, or more preferably about 20 μm or greater (e.g., above 20 μm). From the standpoint of the adhesion and impact resistance, it is yet more preferably about 25 μm or greater, possibly about 30 μm or greater, about 35 μm or greater, or even about 40 μm or greater.

In other embodiments, the PSA sheet thickness is greater than 50 μm. Such a constitution can preferably combine IR-blocking properties and adhesive properties. In this embodiment, the minimum PSA sheet thickness can be 75 μm or greater (e.g., above 75 μm), suitably about 100 μm or greater (e.g., above 100 μm), possibly about 140 μm or greater, or even about 160 μm or greater (e.g., about 180 μm or greater). The PSA sheet thickness can be about 300 μm or less, for instance, about 250 μm or less, about 150 μm or less, about 120 μm or less, or even about 90 μm or less.

### <Applications>

The PSA sheet disclosed herein is suitable for various applications requiring light-blocking properties. For instance, some electronics such as portable electronic devices include luminous components for image displays, etc.; and therefore, the PSA sheet may be required to have light-blocking properties to prevent light leakage and light reflection. With respect to such electronics, the PSA sheet disclosed herein is favorable.

Non-limiting examples of the portable electronic device include cell phones, smartphones, tablet PCs, notebook PCs, various wearable devices (e.g., wrist wears put on wrists such as wrist watches; modular devices attached to bodies with a clip, strap, etc.; eye wears including glass-shaped wears (monoscopic or stereoscopic, including head-mounted pieces); clothing types worn as, for instance, accessories on shirts, socks, hats/caps, etc.; ear wears such as earphones put on ears; etc.), digital cameras, digital video cameras, acoustic equipment (portable music players, IC recorders, etc.), calculators (e.g., pocket calculators), handheld game devices, electronic dictionaries, electronic notebooks, electronic books, vehicle navigation devices, portable radios, portable TVs, portable printers, portable scanners, and portable modems. As used herein, being “portable” means not just providing simple mobility, but further providing a level of portability that allows an individual (average adult) to carry it relatively easily.

Among these portable electronic devices, in a portable electronic device having a pressure sensor, the PSA sheet disclosed herein can be preferably used for fixing the pressure sensor and other components. In some preferable embodiments, the PSA sheet can be used for fixing a pressure sensor and other components in an electronic device (typically, a portable electronic device) equipped with a function to identify an absolute position on a panel corresponding to a screen (typically, a touch panel) with a device to specify the position on the screen (typically, a pen type or a mouse type device) and a device to detect the position.

The PSA sheet disclosed herein is suitable for an application in which it is placed on the back of a display (screen) such as a touch panel display in a portable electronic device to prevent light reflection on the display screen. Placement of the PSA sheet disclosed herein on the back of the display (screen) can prevent degradation of display visibility regardless of how the portable electronic device is used. The refection may be caused by a metallic component placed on the backside of the display screen. For instance, when the PSA sheet disclosed herein is used for the metallic component and the screen, light-blocking properties can be obtained along with attachment of the components.

For instance, adhesively single-faced PSA sheets can be used for design purposes such as article decoration, or as protective materials or sealing materials. As for use in electronic devices such as portable electronics, single-faced PSA sheets can be used for providing light-blocking properties to the surroundings of smartphone cameras, or as covering materials to cover sides of viewing areas in head-mounted displays. Such light-blocking single-faced PSA sheets may also provide design features to article exteriors.

The PSA sheet disclosed herein is suitable for use in an electronic device (e.g., portable electronic device) comprising an internal optical sensor. Various devices such as the aforementioned sort of portable electronic devices may have optical sensors using light such as IR light, visible light and UV light for purposes including personal authentication, device operation, nearby object detection, detection of the surrounding brightness (ambient light) and data communication. While no particular limitations are imposed, examples of the light sensor include an accelerometer, proximity sensor and brightness sensor (ambient light sensor). Such optical sensors have photodetector elements for light such as UV light, visible light and IR light and may also have emitters for specific light such as IR light. In other words, the optical sensor may include an emitter and/or a photodetector element for light in a specific wavelength region in the wavelength spectrum including UV light, visible light and iR light. Here, the optical sensor is defined to have at least an emitter or a photodetector for light having a specific wavelength (e.g., IR). The art disclosed herein can be applied to such a device to reduce reflection of the light used in the optical sensor, thereby preventing deterioration of sensor accuracy.

Preferable applications of the PSA sheet disclosed herein include an electronic device comprising an IR sensor (having an internal IR sensor). The PSA sheet disclosed herein has excellent IR-blocking properties. Thus, when used for fixing, protecting, covering or sealing a member or the like in the electronic device, it can effectively block IR reducing the influence of external light on the accuracy of the IR sensor. Such an electronic device may have a biological authentication system using biometric authentication technology for authenticating individuals based on biological information such as fingerprints and veins. In such personal identification, an IR sensor can be used. Examples of the electronic device include a portable electronic device having a biometric authentication system that allows personal identification by fingerprints and the like as well as various biometric authentication systems.

Other favorable examples of the electronic device (typically a portable electronic device) comprising an IR sensor include a device such as a remote controller (remote control device) whose main body operates with an IR sensor. In such a device, it is not desirable to have IR leakage elsewhere besides from the light-emitting part pointed at the target. Therefore, it is particularly significant to use the PSA sheet disclosed herein to block IR and prevent the IR emitted from inside the device from leaking elsewhere besides from the light-emitting part. The use of the art disclosed herein for such a purpose can prevent malfunction and accuracy degradation of the optical sensor.

Examples of the material (adherend material) to which the PSA sheet disclosed herein is applied include, but are not limited to, metals such as copper, silver, gold, iron, tin, palladium, aluminum, nickel, titanium, chromium, zinc and an alloy of two or more species among these; various resin materials (typically, plastic materials) such as polyimide resin, acrylic resin, polyether nitrile resin, polyether sulfone resin, polyester resin (PET resin, polyethylene naphthalate resin, etc.), polyvinyl chloride resin, polyphenylene sulfide resin, polyether ether ketone resin, polyamide resin (so-called aramid resin, etc.), polyarylate resin, polycarbonate resin, and liquid crystal polymer, inorganic materials such as alumina, zirconia, soda glass, silica glass and carbon. Among them, metals such as copper, aluminum, and stainless steel, and resin materials (typically plastic materials) such as polyester resin (PET resin, etc.), polyimide resin, aramid resin and polyphenylene sulfide resin are widely used. The material may constitute a member of a product such as an electronic device. The PSA sheet disclosed herein can be applied to a member formed from the material. The material may constitute an article to be fixed (e.g., a backside member such as an electromagnetic wave shield and a reinforcing sheet) in the pressure sensor, screen, etc. The article to be fixed refers to the target object to which the PSA sheet is applied, that is, the adherend. For instance, in a portable electronic device, the backside member refers to a member placed on the opposite side to the front face (visible side) of the pressure sensor or screen. The article to be fixed may have a single layer structure or a multilayer structure, and its surface (face to be attached) to which the PSA sheet is applied may be subjected to various types of surface treatment. The article to be fixed is not particularly limited. One example is a backside component having a thickness of about 1 μm or greater (typically, 5 μm or greater, for example, 60 μm or greater, and also 120 μm or greater) and about 1500 μm or less (e.g., 800 μm or less), but these values are not particularly limiting.

The PSA sheet disclosed herein may have excellent light-blocking properties including IR-blocking properties and thus is preferably used in electronic devices that include various light sources such as LED (light-emitting diodes) and luminous components such as self-luminous organic EL (electro-luminescence). For instance, it can be preferably used in an electronic device (typically a portable electronic device) having a liquid crystal display that requires certain optical properties. More specifically, it can be preferably used in a liquid crystal display having a liquid crystal display module unit (LCD unit) and a backlight module unit (BL unit) to join the LCD and BL units.

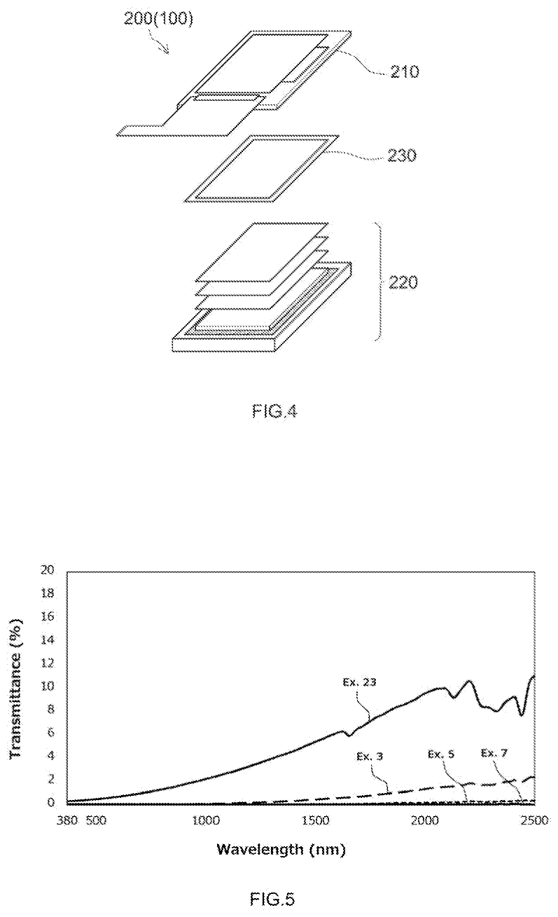

FIG. 4 shows an exploded perspective view schematically illustrating a constitutional example of the liquid crystal display. As shown in FIG. 4, a liquid crystal display 200 having a portable electronic device 100 comprises an LCD unit (component) 210 and a BL unit (component) 220. Liquid crystal display 200 further comprises a PSA sheet 230. In this constitutional example, PSA sheet 230 is in a form of an adhesively double-faced PSA sheet (double-faced PSA sheet) processed into a frame shape and is placed between BL unit 220 and LCD unit 210 joining the two. It is noted that BL unit 220 typically includes, besides a light source, a reflective sheet, a light-guiding panel, a diffusion sheet, a prism sheet, etc.

The PSA sheet disclosed herein can be processed into joints having various shapes and used, for instance, for joining the LCD and BL units as well as for other joining purposes. In a preferable embodiment, the joint has a narrow segment having a width less than 2.0 mm (e.g., less than 1.0 mm). The PSA sheet according to some preferable embodiments may show excellent light-blocking properties. Thus, it can produce good performance even when used as a joint having a shape (e.g., a frame shape) with such a narrow segment. In some embodiments, the narrow segment may have a width of 0.7 mm or less, 0.5 mm or less, or even about 0.3 mm or less. The minimum width of the narrow segment is not particularly limited. From the standpoint of the handling properties of the PSA sheet, it is suitably 0.1 mm or greater (typically 0.2 mm or greater).

The narrow segment is typically linear. Here, the concept of being linear encompasses shapes that are straight, curved, bent (e.g., L-shaped) and also ring-shaped (frame-shaped, circular, etc.) as well as their composite or intermediate shapes. The ring shape is not limited to a curved shape. The concept encompasses, for instance, a ring shape of which part or all is straight, such as a shape that conforms to the circumference of a square (i.e., a frame shape) and a shape that conforms to a sector shape. The narrow segment is not particularly limited in length. For instance, in an embodiment where the narrow segment has a length of 10 mm or greater (typically 20 mm or greater, e.g., 30 mm or greater), the effect of the art disclosed herein can be favorably obtained.

The matters disclosed by this description include the following:

(1) A liquid crystal display having a liquid crystal display module unit, a backlight module unit, and an adhesively double-faced PSA sheet joining the liquid crystal display module unit and the backlight module unit, wherein

the PSA sheet has a PSA layer and has a thickness-direction light transmittance in 780-2500 nm wavelength region of 5% or lower.

(2) The liquid crystal display according to (1) above, comprising an internal optical sensor that comprises an emitter and/or a photodetector element for light in a specific wavelength region in the wavelength spectrum including UV light, visible light and IR light.
(3) The liquid crystal display according to (1) or (2) above, comprising an IR sensor.
(4) The liquid crystal display according to any of (1) to (3) above, wherein the PSA sheet has an in-plane-direction light transmittance in 380-2500 nm wavelength region of 0.01% or lower.
(5) The liquid crystal display according to any of (1) to (4) above, wherein the PSA sheet has a substrate layer supporting the PSA layer and the substrate layer is formed of a resin film comprising a black colorant.
(6) The liquid crystal display according to (5) above, wherein the substrate layer has a thickness accounting for 40% or more of the total PSA sheet thickness.
(7) The liquid crystal display according to (5) or (6) above, wherein the substrate layer has a thickness of 10 μm or greater and 50 μm or less.
(8) The liquid crystal display according to any of (1) to (4) above, wherein the PSA sheet is a substrate-free double-faced PSA sheet consisting of the PSA layer.
(9) The liquid crystal display according to any of (1) to (8) above, wherein the PSA layer comprises a black colorant having a mean particle diameter of 10 nm or greater and less than 1000 nm.
(10) The liquid crystal display according to any of (1) to (9) above, wherein the PSA sheet has a 180° peel strength to stainless steel plate of 2 N/25 mm or greater.
(11) A PSA sheet having a PSA layer, the PSA sheet having a thickness-direction light transmittance in 780-2500 nm wavelength region of 5% or lower.
(12) The PSA sheet according to (11) above, having an in-plane-direction light transmittance in 380-2500 nm wavelength region of 0.01% or lower.
(13) The PSA sheet according to (11) or (12) above, having a substrate layer supporting the PSA layer, wherein the substrate layer is formed of a resin film comprising a black colorant.
(14) The PSA sheet according to (13) above, wherein the substrate layer has a thickness accounting for 40% or more of the total PSA sheet thickness.
(15) The PSA sheet according to (13) or (14) above, wherein the substrate layer has a thickness of 10 μm or greater and 50 μm or less.
(16) The PSA sheet according to (11) or (12) above, that is a substrate-free double-faced PSA sheet consisting of the PSA layer.
(17) The PSA sheet according to any of (11) to (16) above, wherein the PSA layer comprises a black colorant having a mean particle diameter of 10 nm or greater and less than 1000 nm.
(18) The PSA sheet according to any of (11) to (17) above, having a total thickness of 10 μm or greater and less than 75 μm.
(19) The PSA sheet according to any of (11) to (17) above, having a total thickness of greater than 50 μm and 300 μm or less.
(20) The PSA sheet according to any of (11) to (19) above, having a 180° peel strength to stainless steel plate of 2 N/25 mm or greater.
(21) The PSA sheet according to any of (11) to (20) above, that is used in an electronic device comprising a luminous component.
(22) The PSA sheet according to any of (11) to (21) above, used for fixing a component in a portable electronic device.
(23) The PSA sheet according to any of (11) to (22) above, that is used in a portable electronic device comprising an internal optical sensor.
(24) The PSA sheet according to any of (11) to (23) above, that is used in an electronic device comprising an internal IR sensor.
(25) An electronic device having the PSA sheet according to any of (11) to (20) above.
(26) The electronic device according to (25) above, comprising a luminous component.
(27) A portable electronic device comprising the PSA sheet according to any of (11) to (20) above, and a member fixed with the PSA sheet.
(28) The electronic device according to any of (25) to (27) above, comprising an internal optical sensor.
(29) The electronic device according to any of (25) to (27) above, comprising an internal IR sensor.

### EXAMPLES

Several examples relating to the present invention will be described hereinbelow, but the present invention is not to be limited to these examples. In the description below, the“parts” and “^{%}” indicating amounts included or used are by weight unless otherwise specified.

### <Test Methods>

### [In-Plane-Direction Light Transmittance]

With a hand roller, layers of each PSA sheet are laminated with care not to trap air bubbles to obtain a PSA sheet laminate having a total thickness of at least 25 mm up to 30 mm. The laminate is cut to a 02 mm wide strip and the resultant is used as a measurement sample. The in-plane-direction light transmittance (02 mm distance) is determined using a spectrophotometer, by illuminating a side (an edge face) of the measurement sample (0.2 mm wide PSA sheet laminate) with vertical incident light of 380 nm to 2500 nm in wavelength and measuring the intensity of the light transmitted to the opposite edge face. As the spectrophotometer, a spectrophotometer (model number U-4100) available from Hitachi High-Technologies Corporation or a comparable product is used.

### [Thickness-Direction Light Transmittance]

This can be obtained by obtaining a PSA sheet and measuring the light transmittance in the thickness direction thereof. The light transmittance measurement conditions (wavelength, devices used, etc.) are the same as the in-plane-direction light transmittance.

### [180° Peel Strength (Adhesive Strength)]

In a measurement environment at 23° C. and 50% RH, to one adhesive face of a PSA sheet (double-faced PSA sheet), 50 μm thick PET film is applied for backing. The resultant is cut into a 25 mm wide and 100 mm long size to prepare a measurement sample. In an environment at 23° C. and 50% RH, the adhesive face of the measurement sample is press-bonded to the surface of a stainless steel plate (SUS 304BA plate) with a 2 kg roller moved back and forth once. The resultant is allowed to stand for 30 minutes in the same environment. Subsequently, based on JIS Z 0237:2000, using a universal tensile and compression tester, at a tensile speed of 300 mm/min at a peel angle of 180°, the peel strength (adhesive strength)(N/25 mm) is determined. As the universal tensile and compression tester, for instance, “tensile compression tester TG-1 kN” by Minebea Co., Ltd., or an equivalent device is used. In case of a single-faced PSA sheet, the PET film backing is unnecessary.

### Example 1

### (Preparation of PSA Composition)

Into a reaction vessel equipped with a stirrer, thermometer, nitrogen inlet, condenser and dropping funnel, were placed 95 parts of BA and 5 parts of AA as starting monomers and 233 parts of ethyl acetate as the polymerization solvent. The resulting mixture was allowed to stir under a nitrogen flow for two hours to eliminate oxygen from the polymerization system. Subsequently, was added 0.2 part of 22′-azobisisobutylonitrile as the polymerization initiator. The solution polymerization was carried out at 60° C. for eight hours to obtain a solution of acrylic polymer. The acrylic polymer had a Mw of about 70×10⁴.

To the acrylic polymer solution, relative to 100 parts of acrylic polymer in the solution, were added 0.4 part of 1,2,3-benzotriazole (product name BT-120 available from Johoku Chemical Co., Ltd.), 20 parts of a terpene phenolic resin (product name YS POLYSTAR T-115, a softening point of about 115° C., a hydroxyl value of 30 mgKOH/g to 60 mgKOH/g, available from Yasuhara Chemical Co., Ltd.) as a tackifier resin, and 3 parts of an isocyanate-based crosslinking agent (product name CORONATE L, a 75% ethyl acetate solution of a trimethylolpropane/tolylene diisocyanate trimer adduct, available from Tosoh Corporation) and 0.01 part of an epoxy-based crosslinking agent (product name TETRAD-C, 1,3-bis(N,N-diglycidylaminomethyl)cyclohexane, available from Mitsubishi Gas Chemical Co., Inc.) as crosslinking agents. To this, was further added a carbon black dispersion (product name ATDN101 BLACK available from Dainichiseika Color & Chemicals Mfg. Co., Ltd.) and allowed to stir and mix to prepare a PSA composition. The carbon black (CB) dispersion was added to the PSA composition to a CB content of 2 parts to 100 parts of acrylic polymer. As for the CB dispersion, using a product name MICROTRAC MT3000II available from MicrotracBEL Corporation, CB particle diameters were measured and the mean particle diameter (median volume diameter) was found to be 197 nm.

### (Preparation of PSA Sheet)

As release liners, were obtained two sheets of polyester release film (product name DIAFOIL MRF, 38 μm thick, available from Mitsubishi Polyester Film Inc.) with one face being a release face treated with release agent. To the respective release faces of these release liners, the PSA composition was applied to dry thicknesses of 4 μm and allowed to dry at 100° C. for 2 min. PSA layers were thus formed on the release faces of the two release liners.

As the substrate, was used 12 μm thick black PET film (available from Nan Ya Corporation) with CB particles compounded therein. The CB particle content of this substrate is 6%. To the first and second faces of the substrate, were adhered the PSA layers formed on the two release liners to prepare a substrate-supported double-faced PSA sheet according to this Example (transfer method). The release liners were left as they were on the PSA layers and used to protect the surfaces (adhesive faces) of the PSA layers.

### Examples 2 to 10

The PSA layers were formed to have the thicknesses shown in Table 1. Using the substrates (substrate layers) shown in Table 1, but otherwise in the same manner as the preparation of the PSA sheet according to Example 1, were prepared substrate-supported double-faced PSA sheets according to the respective Examples. As the 25 μm thick black substrate layer, was used black PET film (available from Toray Industries, Inc.; containing 5% CB particles) with CB particles compounded therein. As the 5 μm thick black substrate layer, was used black PET film (available from Toray Industries, Inc.; containing 10% CB particles) with CB particles compounded therein. As the 50 μm, 75 μm and 125 μm thick black substrate layers, was used black PET film (available from Toray Industries, Inc.; containing 1% CB particles) with CB particles compounded therein.

### Example 11

To the release face of a release liner, the PSA composition prepared in Example 1 was applied to a thickness of 10 μm after dried and allowed to dry at 100° C. for 2 minutes to form a PSA layer on the release liner's release face. As the substrate, was obtained 10 μm thick black PET film (available from Toray Industries, Inc., containing 10% CB particles) with CB particles compounded therein. To one face (single face) thereof, was adhered the PSA layer formed on the release liner to prepare a substrate-supported single-faced PSA sheet according to this Example.

### Examples 12 to 15

The PSA layers were formed to have the thicknesses shown in Table 2. Using the substrates (substrate layers) shown in Table 2, but otherwise in the same manner as the preparation of the PSA sheet according to Example 11, were prepared substrate-supported single-faced PSA sheets according to the respective Examples. As the 25 μm thick black substrate layer, was used black PET film (available from Toray Industries, Inc.; containing 5% CB particles) with CB particles compounded therein. As the 50 μm and 75 μm thick black substrate layers, was used black PET film (available from Toray Industries. Inc.; containing 1% CB particles) with CB particles compounded therein.

### Example 16

In preparation of the PSA composition according to Example 1, the amount of CB particles was changed to 10 parts to 100 parts of acrylic polymer. Otherwise in the same manner as Example 1, was prepared a PSA composition. To the release face of a release liner, the resulting PSA composition was applied and allowed to dry at 100° C. for 2 minutes to form a 35 μm thick PSA layer. To this PSA layer, was adhered the release face of another release liner. In this manner, was obtained a 35 μm thick substrate-free double-faced PSA sheet with both faces protected with the two release liners.

### Example 17

To the release face of a release liner, the PSA composition prepared in Example 1 was applied and allowed to dry at 100° C. for 2 minutes to form a 70 μm thick PSA layer. To this PSA layer, was adhered the release face of another release liner. In this manner, was obtained a 70 μm thick substrate-free double-faced PSA sheet with both faces protected with the two release liners.

### Example 18

CB particles were not used. Otherwise, by the same method as Example 1, was prepared a PSA composition. In this Example, as the substrate, was used a multilayer substrate (˜17 μm in total thickness) formed of 12 μm thick transparent PET film (available from Toray Industries, Inc.) and a black color printed layer provided on the second face thereof. The black color printed layer was formed by gravure printing with a black colorant-containing ink composition. The amount of the PSA composition applied to the release film was adjusted to obtain a dry thickness of 16.5 μm. Otherwise in the same manner as the preparation of the PSA sheet according to Example 1, was prepared a substrate-supported double-faced PSA sheet according to this Example.

### Example 19

As the substrate, was used a multilayer substrate (˜28 μm in total thickness) formed of transparent PET film (available from Toray Industries. Inc.) and a black color printed layer provided on the second face thereof. The amount of the PSA composition applied to the release film was adjusted to a thickness of 36 μm after dried. Otherwise, in the same manner as Example 18, was prepared a PSA sheet according to this Example.

### Example 20

CB particles were not used. Otherwise, by the same method as Example 1, was prepared a PSA composition; and by the same method as Example 1, was formed a 37.5 μm thick PSA layer on the release face of a release liner. In this Example, as the substrate, was used a 25 μm thick black substrate layer (black PET film with CB particles compounded therein, available from Toray Industries, Inc., containing 5% CB particles). Otherwise, in the same manner as Example 1, was prepared a PSA sheet according to this Example.

### Examples 21 to 23

In preparation of the PSA composition according to Example 1, the amount of CB particles to 100 parts of acrylic polymer was changed to 0.7 part (Ex. 21) or 1 part (Ex. 22). Otherwise in the same manner as Example 1, were prepared PSA compositions. In addition, was obtained a PSA composition having the same composition as Example 1 (containing 2 parts of CB particles to 100 parts of acrylic polymer)(Ex. 23).

To the release face of a release liner, each PSA composition obtained above was applied and allowed to dry at 100° C. for 2 minutes to form a 35 μm thick PSA layer. To the resulting PSA layer, was adhered the release face of another release liner. In this manner, was obtained a substrate-free double-faced PSA sheet (35 μm thick) according to each Example. In the PSA sheet according to each Example, both faces are protected with the two release liners.

### <Evaluations>

With respect to the PSA sheet according to each Example, were determined the in-plane-direction light transmittance (%), thickness-direction light transmittance (%) and 180° peel strength (N/25 mm). The results are shown in Tables 1 and 2. Each Table shows the in-plane-direction 500 nm and 2000 nm wavelength transmittances (%) as well as the thickness-direction 2000 nm wavelength transmittance (%). FIG. 5 shows the thickness-direction 380-2500 nm wavelength light transmittances (%) of the PSA sheets according to Examples 3, 5, 7 and 23. Each Table also summarizes the features of

TABLE 1

| | | Ex. 1 | Ex. 2 | Ex. 3 | Ex. 4 | Ex. 5 | EX. 6 |
|---|---|---|---|---|---|---|---|
| Constitution | | Substrate-supported double-faced | | | | | |
| Total thickness (μm) | | 20 | 30 | 30 | 50 | 50 | 80 |
| PSA layer | Black colorant (pt)* | 2 | 2 | 2 | 2 | 2 | 2 |
| | Thickness (μm) | 4 | 2.5 | 12.5 | 12.5 | 19 | 27.5 |
| Substrate layer (thickness in μm) | | Black (12) | Black (25) | Black (5) | Black (25) | Black (12) | Black (25) |
| Substrate thickness/total thickness (%) | | 60.0 | 83.3 | 16.7 | 50.0 | 24.0 | 31.3 |
| Thickness-direction transmittance (2000 nm) | | 0.07% | <0.01% | 1.30% | <0.01% | 0.17% | <0.01% |
| In-plane- | (2000 nm) | <0.01% | <0.01% | <0.01% | <0.01% | <0.01% | <0.01% |
| direction | | | | | | | |
| transmittance | (500 nm) | <0.01% | <0.01% | <0.01% | <0.01% | <0.01% | <0.01% |

| | | | | | | |
|---|---|---|---|---|---|---|
| Adhesive strength (N/25 mm) | 5.2 | 4.1 | 14.7 | 13.7 | 16.3 | 17.3 |

| | | Ex. 7 | Ex. 8 | Ex. 9 | Ex. 10 |
|---|---|---|---|---|---|
| Constitution | | Substrate-supported double-faced | | | |
| Total thickness (μm) | | 100 | 120 | 150 | 200 |
| PSA layer | Black colorant (pt)* | 2 | 2 | 2 | 2 |
| | Thickness (μm) | 37.5 | 35 | 37.5 | 37.5 |
| Substrate layer (thickness in μm) | | Black (25) | Black (50) | Black (75) | Black (125) |
| Substrate thickness/total thickness (%) | | 25.0 | 41.7 | 50.0 | 62.5 |
| Thickness-direction transmittance (2000 nm) | | <0.01% | <0.01% | <0.01% | <0.01% |
| In-plane- | (2000 nm) | <0.01% | <0.01% | <0.01% | <0.01% |
| direction | | | | | |
| transmittance | (500 nm) | <0.01% | <0.01% | <0.01% | <0.01% |

| | | | | |
|---|---|---|---|---|
| Adhesive strength (N/25 mm) | 18.5 | 19.0 | 21.5 | 13.4 |

*parts relative to base polymer

TABLE 2

| | | Ex. 11 | Ex. 12 | Ex. 13 | Ex. 14 | Ex. 15 | Ex. 16 | Ex. 17 |
|---|---|---|---|---|---|---|---|---|
| Constitution | | substrate-supported single-faced | | | | | Substrate-free double-faced | |
| Total thickness (μm) | | 20 | 30 | 50 | 75 | 100 | 35 | 70 |
| PSA layer | Black colorant (pt)* | 2 | 2 | 2 | 2 | 2 | 10 | 2 |
| | Thickness (μm) | 10 | 5 | 25 | 25 | 25 | 35 | 70 |
| Substrate layer (thickness in μm) | | Black (10) | Black (25) | Black (25) | Black (50) | Black (75) | — | — |
| Substrate thickness/total thickness (%) | | 50.0 | 83.3 | 50.0 | 66.7 | 75.0 | — | — |
| Thickness-direction transmittance (2000 nm) | | <0.01% | <0.01% | <0.01% | <0.01% | <0.01% | <0.01% | 1.04% |
| In-plane-direction | (2000 nm) | <0.01% | <0.01% | <0.01% | <0.01% | <0.01% | <0.01% | <0.01% |
| transmittance | (500 nm) | <0.01% | <0.01% | <0.01% | <0.01% | <0.01% | <0.01% | <0.01% |

| | | | | | | | |
|---|---|---|---|---|---|---|---|
| Adhesive strength (N/25 mm) | 10.3 | 4.6 | 11.8 | 12.2 | 12.5 | 2.2 | 20.5 |

| | | Ex. 18 | Ex. 19 | Ex. 20 | Ex. 21 | Ex. 22 | Ex. 23 |
|---|---|---|---|---|---|---|---|
| Constitution | | Substrate-supported double-faced | | | Substrate- free double-faced | | |
| Total thickness (μm) | | 50 | 100 | 100 | 35 | 35 | 35 |
| PSA layer | Black colorant (pt)* | 0 | 0 | 0 | 0.7 | 1 | 2 |
| | Thickness (μm) | 16.5 | 36 | 37.5 | 35 | 35 | 35 |
| Substrate layer (thickness in μm) | | Transparent + | Transparent + | Black (25) | — | — | — |
| | | black color | black color | | | | |
| | | print (17) | print (28) | | | | |
| Substrate thickness/total thickness (%) | | 34.0 | 28.0 | 25.0 | — | — | — |
| Thickness-direction transmittance (2000 nm) | | <0.01% | <0.01% | <0.01% | 62.80% | 31.90% | 9.55% |
| In-plane-direction | (2000 nm) | >70% | >70% | >70% | 0.02% | 0.01% | <0.01% |
| transmittance | (500 nm) | >70% | >70% | >70% | <0.01% | <0.01% | <0.01% |

| | | | | | | |
|---|---|---|---|---|---|---|
| Adhesive strength (N/25 mm) | 11.8 | 16 | 19 | 19.8 | 19.3 | 18.8 |

*parts relative to base polymer

As shown in Tables 1 and 2, in Examples 1 to 17, constitutions having 5% or lower thickness-direction 2000 nm wavelength light transmittance and 0.01% or lower in-plane-direction 500 nm and 2000 nm wavelength light transmittances were obtained as substrate-supported double-faced PSA sheets, substrate-supported single-faced PSA sheets or substrate-free double-faced PSA sheets. The results shown in FIG. 5 indicate that these PSA sheets have 5% or lower thickness-direction light transmittances in 780-2500 nm wavelength region and 0.01% or lower in-plane-direction light transmittances in 380-2500 nm wavelength region. It is noted that in these Examples, the thickness-direction 500 nm wavelength light transmittances were below 0.01%. Evidently, these PSA sheets block light in the IR region well, having excellent light-blocking properties. On the other hand, the PSA sheets according to Examples 18 to 23 did not satisfy either the 5% or lower thickness-direction 2000 nm wavelength light transmittance or the 0.01% or in-plane-direction light transmittance.

Although specific embodiments of the present invention have been described in detail above, these are merely for illustrations and do not limit the scope of claims. The art according to the claims includes various modifications and changes made to the specific embodiments illustrated above.

### REFERENCE SIGNS LIST

1, 2, 3 PSA sheets
10 substrate (layer)
10A first face
10B second face
21 first PSA layer (PSA layer)
21A first adhesive face
21B second adhesive face
22 second PSA layer
22A second adhesive face
31, 32 release liners

1-10. (canceled)

11. A liquid crystal display having a liquid crystal display module unit, a backlight module unit, and an adhesively double-faced pressure-sensitive adhesive sheet joining the liquid crystal display module unit and the backlight module unit, wherein
the pressure-sensitive adhesive sheet has a pressure-sensitive adhesive layer and has a thickness-direction light transmittance in 780-2500 nm wavelength region of 5% or lower.

12. The liquid crystal display according to claim 11, further including an optical sensor, wherein the optical sensor comprises one or both of an emitter and a photodetector element for light in a wavelength region within a wavelength spectrum including ultraviolet light, visible light and infrared light.

13. The liquid crystal display according to claim 11, further including an infrared light sensor.

14. The liquid crystal display according to claim 11, wherein the pressure-sensitive adhesive sheet has an in-plane-direction light transmittance in 380-2500 nm wavelength region of 0.01% or lower.

15. The liquid crystal display according to claim 11, wherein the pressure-sensitive adhesive sheet further includes a substrate layer supporting the pressure-sensitive adhesive layer, and the substrate layer is formed of a resin film comprising a black colorant.

16. The liquid crystal display according to claim 15, wherein the substrate layer has a thickness accounting for 40% or more of a total thickness of the pressure-sensitive adhesive sheet.

17. The liquid crystal display according to claim 15, wherein the substrate layer has a thickness of 10 μm or greater and 50 μm or less.

18. The liquid crystal display according to claim 11, wherein the pressure-sensitive adhesive sheet is a substrate-free double-faced pressure-sensitive adhesive sheet consisting of the pressure-sensitive adhesive layer.

19. The liquid crystal display according to claim 11, wherein the pressure-sensitive adhesive layer comprises a black colorant having a mean particle diameter of 10 nm or greater and less than 1000 nm.

20. The liquid crystal display according to claim 11, wherein the pressure-sensitive adhesive sheet has a 180° peel strength to stainless steel plate of 2 N/25 mm or greater.

21. A pressure-sensitive adhesive sheet including a pressure-sensitive adhesive layer,
wherein the pressure-sensitive adhesive sheet has:
a thickness-direction light transmittance in 780-2500 nm wavelength region of 5% or lower, and
an in-plane-direction light transmittance in 380-2500 nm wavelength region of 0.01% or lower.

22. The pressure-sensitive adhesive sheet according to claim 21, wherein the pressure-sensitive adhesive sheet includes a substrate layer supporting the pressure-sensitive adhesive layer, and the substrate layer is formed of a resin film comprising a black colorant.

23. The pressure-sensitive adhesive sheet according to claim 22, wherein the substrate layer has a thickness accounting for 40% or more of a total thickness of the pressure-sensitive adhesive sheet.

24. The pressure-sensitive adhesive sheet according to claim 22, wherein the substrate layer has a thickness of 10 μm or greater and 50 μm or less.

25. The pressure-sensitive adhesive sheet according to claim 21, wherein the pressure-sensitive adhesive sheet is a substrate-free double-faced pressure-sensitive adhesive sheet consisting of the pressure-sensitive adhesive layer.

26. The pressure-sensitive adhesive sheet according to claim 21, wherein the pressure-sensitive adhesive layer comprises a black colorant having a mean particle diameter of 10 nm or greater and less than 1000 nm.

27. The pressure-sensitive adhesive sheet according to claim 21, having a total thickness of 10 μm or greater and less than 75 μm.

28. The pressure-sensitive adhesive sheet according to claim 21, having a total thickness of greater than 50 μm and 300 μm or less.

29. The pressure-sensitive adhesive sheet according to claim 21, having a 180° peel strength to stainless steel plate of 2 N/25 mm or greater.

30. The pressure-sensitive adhesive sheet according to claim 21, in use for fixing a member in an electronic device comprising an infrared light sensor.
